(19) United States
(12) Patent Application Publication
(10) Pub. No.: US 2009/0125323 A1
(43) Pub. Date: May 14, 2009

(54) OBTAINMENT OF PRODUCTS AND SERVICES USING NON-FINANCIAL TRANSACTIONS CONDUCTED OVER A FINANCIAL NETWORK

(76) Inventors: Kris Lakshmanan, Piscataway, NJ (US); Joseph D. Macaluso, Sparta, NJ (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/252,273

(22) Filed: Oct. 15, 2008

Related U.S. Application Data
(60) Provisional application No. 60/980,396, filed on Oct. 16, 2007.

(51) Int. Cl. G06Q 30/00; G06Q 50/00; G06Q 20/00

(52) U.S. Cl. 705/2; 705/34; 235/380; 705/17; 705/26

(57) ABSTRACT

Methods and systems for facilitating obtaining products and/or services using non-financial transactions over a financial transaction network are provided. Example embodiments provide a Single Swipe Obtainment System, which initiates providing requested product(s) in response to a non-financial transaction via a financial network. A non-financial entity supplies a card to each user. Items may be subsequently ordered by a user swiping the card in a point-of-sale device and entering a code associated with the requested item. When the code is received via the financial network by the non-financial entity, a product or service associated with the code is determined and supplied to the user, such as by shipping the associated product or service to the user. This abstract is provided to comply with rules requiring an abstract, and it is submitted with the intention that it will not be used to interpret or limit the scope or meaning of the claims.

### TECHNICAL FIELD

The present disclosure relates to methods, techniques, and systems for obtaining products and/or services and, in particular, to methods and systems for obtaining products and/or services, such as pharmaceutical samples, using non-financial transactions over a financial transaction network, such as a credit or debit card processing network.

### BACKGROUND

Industry continues to experience extreme pressure to transform. Increasingly, industry needs secure, cost-effective solutions to supply products and/or services to customers. A large sales force that supplies product samples to professionals and acts as a liaison between the customer and the company is expensive, especially to rural areas or areas with few or physically distributed customers. Moreover, many industries, such as the pharmaceutical and chemical industries, are highly regulated and need secure, auditable methods of requesting product and tracking product delivery. For example, in the pharmaceutical industry, physician samples as well as prescription drugs are required to be distributed according to strict federal guidelines. Even in industries that are not highly regulated, there are a number of situations where one or more products or services are desired to be restricted to a limited group of identifiable people, such as a request of a product sample from a wholesale distributor to a retail outlet store.

As one example, the pharmaceutical industry continues to experience extreme economic pressure to transform. In order to get new drugs in the hands of patients, it is advantageous for manufacturers to get pharmaceutical samples into the hands of healthcare professionals in a timely fashion and with sufficient information to assist such professionals in prescribing them. Traditional methods for distributing pharmaceutical samples include sending sales representatives, such as manufacturer or contract sales representatives to visit and meet with such healthcare professionals to distribute samples. The healthcare professionals typically sign for products received, either electronically or by paper. The sales representatives may take orders by various methods including paper forms, electronic computing device interfaces, etc. Once ordered, information is transmitted, for example, to the manufacture, who later directs fulfillment of the sample request. Alternatively, some healthcare professionals do not wish to be visited by sales representatives or may wish to have more timely access to samples that is not be dependent upon sales representative visits. Such healthcare professionals may be given Web site access to order samples electronically. Or, they may order samples via fax order or a telephone call to call center, for example, directly to a pharmaceutical company or other fulfillment center.

Current methods for providing pharmaceutical samples to healthcare professionals are expensive and time consuming. In sparsely-populated areas, it is no longer cost-effective to send a pharmaceutical representative to healthcare providers' offices to interface with the healthcare professionals (e.g., physicians) and to provide pharmaceutical samples. In some areas, such as widely dispersed areas, visits to each physician may be infrequent. Moreover, when a sales representative assigned to a region is not available, for example because the representative has resigned, taken a leave of absence, etc., the physician may not be visited at all for some period of time. Also, physicians may be grouped or targeted by the representatives and visited based upon the frequency particular products are prescribed, and thus some physicians may be visited less than others even within the same geographic area.

In addition, there are practical limits on how many products a single pharmaceutical representative can transport and be knowledgeable about. Furthermore, laws and regulations, such as the federal Pharmaceutical Drug Manufacturing Act (“PDMA”), require accounting of pharmaceutical samples from manufacture through distribution to healthcare professionals that are authorized to prescribe pharmaceutical compositions.

### BRIEF DESCRIPTION OF THE FIGURES

FIG. 1 illustrates a single swipe sampling card according to an example embodiment of the Single Swipe Obtainment System.

FIG. 2 illustrates a physician using a single swipe sampling card according to an example embodiments of the Single Swipe Obtainment System.

FIG. 3 illustrates example components of an example embodiment of a Single Swipe Obtainment System and interactions between them.

FIG. 4 illustrates several cards that have been customized for an example single swipe pharmaceutical sample program provided by an example embodiment.

FIGS. 5A-5B illustrate a card mailer used in an example embodiment.

FIGS. 6A-6E illustrate use of an example embodiment with a point-of-sale device for a non-financial transaction.

FIG. 7 is an example flow diagram that overviews a process for providing a product or service obtainment program that operates according to an example Single Swipe Obtainment System.

FIG. 8 is an example flow diagram that illustrates process flow through an example embodiment of the Single Swipe Obtainment System.

FIG. 9 is an example block diagram illustrating transaction processing performed by an example embodiment.

FIG. 10 illustrates one example of a card swipe state data structure utilized by an example embodiment of a Single Swipe Obtainment System.

FIG. 11 illustrates example business rules utilized by an example embodiment.

FIG. 12 illustrates an example process for handling an approved swipe provided by an example embodiment.

FIG. 13 illustrates an example process for handling a denied swipe provided by an example embodiment.

FIGS. 14A-14G illustrate an example Web portal for administering and communicating with a single swipe sampling program used to supply pharmaceutical samples.

FIG. 15 is an example block diagram illustrating an example computing system suitable for executing embodiments of the Single Swipe Obtainment System.

FIG. 16 illustrates one example embodiment of the components of an example NFTPS.

FIG. 17 is an example flow diagram of an example non-financial transaction processing routine provided by an example embodiment.

### DETAILED DESCRIPTION

Embodiments described herein provide enhanced computer- and network-assisted methods, techniques, and systems for ordering or obtaining one or more products or services via a non-financial transaction processed over a financial transaction network, such as a credit and/or debit card processing network. Example embodiments provide a Single Swipe Obtainment System (“SSOS”), which enables businesses and other entities to establish programs for providing one or more product or service items to users, without payment, via the financial transaction network. The programs can be customized as needed for particular usages, such as to comply with any applicable regulatory requirements or to limit frequency, timing of use, etc.

The SSOS uses point-of-sale (“POS”) devices already existent in many businesses to conduct secure transactions to allow a customer, by a single swipe of a credit or debit card, to order a product or service without payment. Each card is coded as a “non-financial transaction” to inform the financial network processors that the card is being used for a non-financial transaction. To operate properly, the financial network is previously configured to distribute and/or handle such non-financial transactions. Information for processing the non-financial transaction is sent by a POS device encoded in fields traditionally used to send financial information in a financial network. For example, along with a unique card identification number (“card ID”), product identification and security codes may be sent in a monetary amount field. These codes are forwarded to, and intended to be interpreted for further processing by, a non-financial transaction processing system, for example, a third party system controlled outside of the financial network, such as by a non-financial institution. Once such information is received, the non-financial transaction processing system determines what action to take, such as notification of a distribution center that a particular order is to be fulfilled.

For illustrative purposes, an embodiment of a SSOS system is described below called “Single Swipe Sampling” in which an SSOS allows a pharmaceutical manufacturer to efficiently distribute pharmaceutical samples to healthcare professionals, such as a doctor or physician assistant. However, it will be appreciated that the described techniques may be used with a wide variety of products or services, with products being provided in manners other than by shipping the products via common carriers, with products and services that are not provided gratuitously, and that this disclosure is not limited to the details provided herein. In addition, various POS devices may be used for such order entry and/or sample requesting, including any POS terminal or other device currently or in the future recognized by financial networks for the processing of credit or debit cards.

Also, although the techniques of Single Swipe Sampling and the Single Swipe Obtainment System are generally applicable to any type of product item or service, the phrase “product” or “service” is used generally to imply any type of thing that may be ordered or obtained using an identification code that can be represented, directly or indirectly, through the codes available over the financial network. Also, although the examples described herein often refer to a pharmaceutical manufacturers, healthcare professionals, doctors, etc., the techniques described herein can also be used by other entities. In addition, the concepts and techniques described are applicable to request auxiliary product or service material, such as information about products, etc. Accordingly, the concepts and techniques described are applicable to any type of non-financial transaction-based order entry or order processing, provided the information can be indexed via codes provided by the swiped card, and a financial transaction processor can be instructed to forward information to one or more non-financial transaction systems for processing.

In addition, although certain terms are used primarily herein, other terms could be used interchangeably to yield equivalent embodiments and examples. For example, equivalent terms could be substituted for such terms as “user,” “customer,” “sample,” “manufacturer,” etc. In addition, terms may have alternate spellings which may or may not be explicitly mentioned, and all such variations of terms are intended to be included.

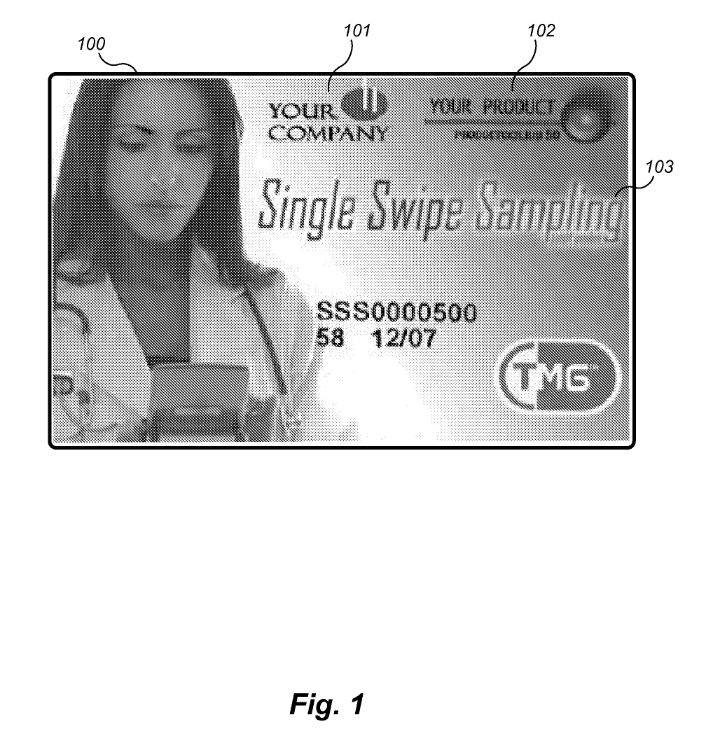

FIG. 1 illustrates a single swipe sampling card according to an example embodiment of the Single Swipe Obtainment System. The illustrated single swipe sampling card 100 is co-branded with a plurality of brand identifiers 101-103. The brand-identifiers 101-103 may indicate, for example, business entities (e.g., corporations, manufacturers, distributors, partnerships, etc.), products (e.g., drugs, medical supplies, consumer or packaged food products, etc.), and/or services.

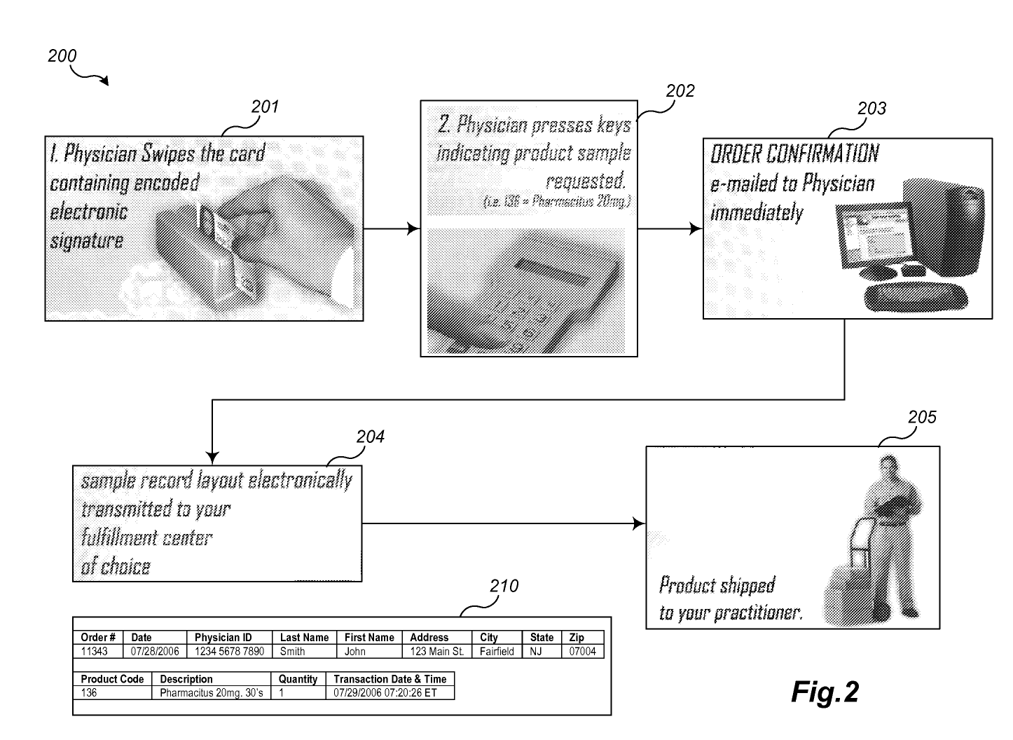

FIG. 2 illustrates a physician using a single swipe sampling card according to an example embodiments of the Single Swipe Obtainment System. In particular, FIG. 2 shows an example ordering process 200 used by a physician to order a product sample.

More specifically, the process 200 starts at step 201, when a physician swipes a single swipe sampling card through a card reader device. The swiped card may contain various information, such as an encoded electronic identifier and/or signature that identifies or is otherwise associated with the physician. Such information may be encoded in various ways, including upon a magnetic strip, a bar code, etc.

In step 202, the physician presses keys on a point-of-sale device indicating the product sample requested. For example, the physician may key the digits “136” to indicate a sample of a drug named “Pharmacitus” in 20 milligram doses (e.g., capsules, pills, etc.).

In step 203, an order confirmation is emailed to the physician. In other embodiments, an order confirmation may be transmitted in other ways, such as by another type of electronic message (e.g., via an HTTP response, etc.), by physical message (e.g., via postal mail, courier service, etc.), by telephone message (e.g., via an automated interactive voice response system).

In step 204, a sample record 210 is transmitted to a fulfillment center. The sample record 210 includes information about the ordering physician, such as a physician identifier, name, and address. The sample record 210 also includes information about the order, such as an order identifier, a product code, a product description, a quantity, and a transaction date/time. Although the sample record 210 shows the same product code being forwarded to the fulfillment center as the code entered by the physician, in other embodiments the SSOS may map the item code entered by the physician to a product code used by the fulfillment center. Other transformations and annotations are also possible.

In step 205, the product sample is shipped to the physician. In the illustrated embodiment, the fulfillment center operates a shipping/receiving facility that is used to initiate the distribution (e.g., via postal mail, courier, etc.) of sample products to various recipients.

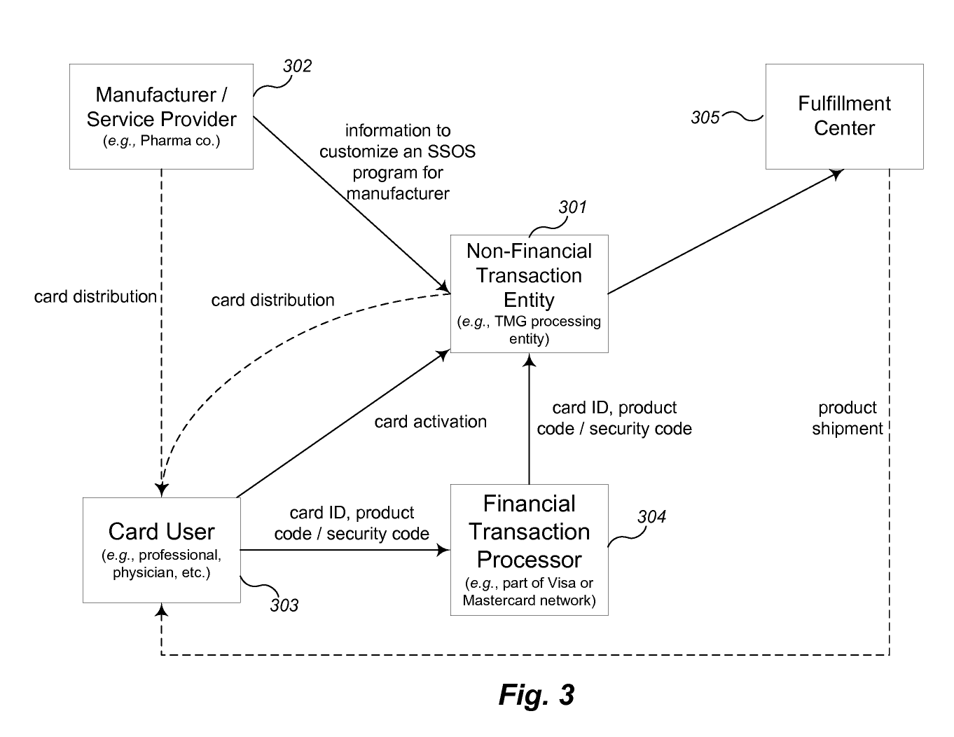

FIG. 3 illustrates example components of an example embodiment of a Single Swipe Obtainment System and interactions between them. Such a Single Swipe Obtainment System (“SSOS”) may be used, for example, to implement the single swipe sampling program described with reference to FIGS. 1 and 2. In one example embodiment, an SSOS comprises a non-financial transaction entity 301, a financial transaction processor 304, a manufacturer or service provider 302, a fulfillment center 305, and a card user 303. These components may be implemented in software or hardware or a combination of both. Financial transaction processors 304 may comprise one or more systems belonging to a financial network, such as those used to process Visa, MasterCard, American Express, Discover cards, etc. The manufacturer or service provider 302 may include one or more entities responsible for providing the card program and the product or service item. The non-financial transaction entity 301 represents one or more entities that administer a single swipe program on behalf of the manufacturer or service provider 302 using one or more non-financial transaction processing systems (“NFTPS”). The fulfillment center 305 represents the one or more entities used to distribute the ordered item, for example, to the card user 303. Of note, although illustrated in this figure as separate entities, one or more of the components, included the non-financial transaction entity 301, the financial transaction processor 304, and the fulfillment center 305, may combined into one or more systems that are operated, or owned by the same or one or more different entities. Further, one or more of the components may not be present in a particular implementation or may be combined with other components to achieve the functionality described herein. For example, in some embodiments, a financial institution (e.g., a bank) may own and operate an SSOS program for its own uses; and what is represented here as “non-financial” transaction entity 301 and the financial transaction processor 304 may belong to the same entity, which may in some embodiments be a financial entity.

When used to provide a single swipe sampling (“SSS”) program for healthcare professionals, the manufacturer 302 is a pharmaceutical manufacturer that contacts a non-financial transaction entity 301 that provides the SSOS and customizes a single swipe program to meet the needs of the pharmaceutical manufacturer 302. The customizations may include, for example, co-branding the single swipe card and/or other materials (e.g., instruction sheets) to be sent to the healthcare professional; providing a marketing list of and/or criteria that target or describe to which healthcare professionals to distribute cards; incentives (e.g., free continuing medical education classes) to encourage healthcare professionals to use the program; determining a list of pharmaceutical samples to distribute via the program; and providing a choice of one or more fulfillment houses to transmit a verified order to so that the product can be provided to the healthcare professional. In other embodiments, more or fewer customizations may be available.

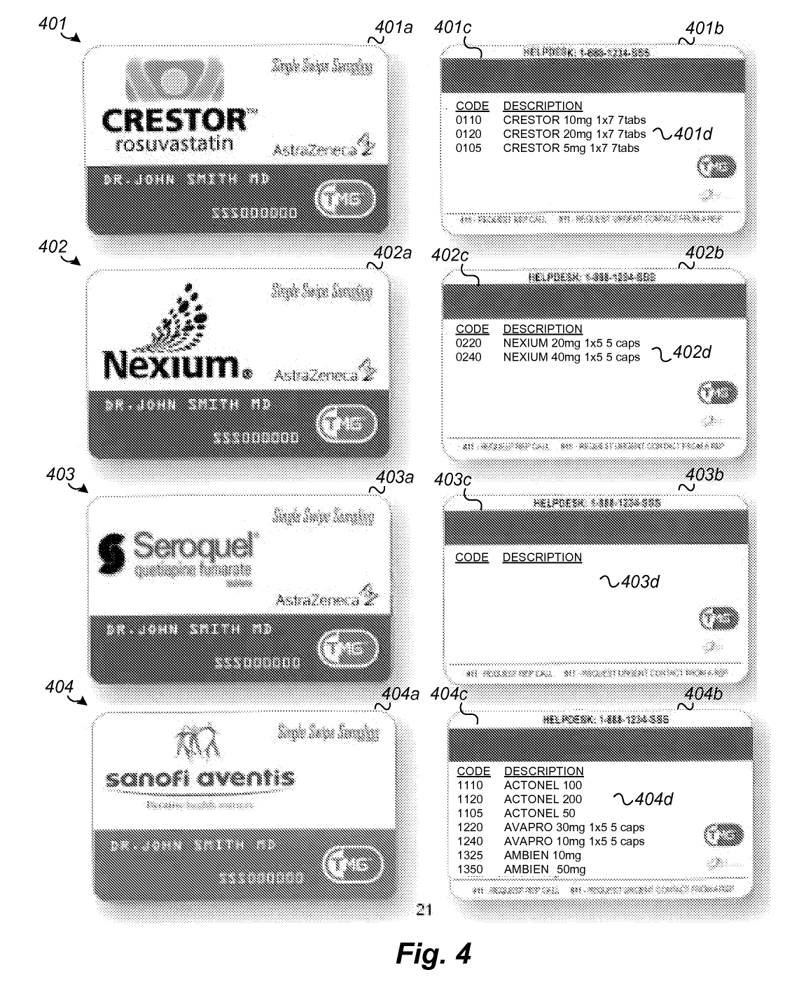

FIG. 4 illustrates several cards that have been customized for an example single swipe pharmaceutical sample program provided by an example embodiment. In particular, FIG. 2 shows fronts 401a-404a and backs 401b-404b of four example cards 401-404. In this example, the front of each card 401a-404a has been co-branded and is preconfigured to include the name of a target healthcare professional. Magnetic strips 401c-404c on the back of each card 401b-404b are used to place secure identifying information (typically a unique identifier) instead of embossing a card ID on the front of the card. In addition, codes 401d-404d for various products and services are printed on the back of each card. As shown, different item codes may be used for different quantities and/or different dosages of a single product, and a single card may support multiple product lines (e.g., all product lines associated with treating a particular medical condition). For example, the codes 402d for card 402 (“the Nexium® card”) include a code 0220 and a separate code 0240 to indicate that samples of Nexium® medication may be ordered in 20 mg and 40 mg does, 5 capsule amounts, respectively. However, card 403 (“the Seroquel® card”) has no item codes 403d printed on the card. In this case, the codes may have been supplied separately (e.g., via a mailer) or an item code may be superfluous if only a single quantity/dosage can be ordered with the card. In the latter case, the card needs only to be swiped and the healthcare professional's security code supplied. Furthermore, a single card may be used in support of multiple product lines. For example, the codes 404d for card 404, which has been branded with the name of a drug manufacturer (“Sanofi Aventis”), indicate that samples of three different drugs may be ordered, including Actonel® medication, Avapro® medication, and Ambien® medication.

Although the cards 401-404 illustrate a four-digit code used to request a sample, in other embodiments, codes of different lengths may be utilized and may consist of alphanumeric characters. Furthermore, in some embodiments, the SSOS prevents providing products or services corresponding to codes that are not associated with the swiped card. For example, if card 401 (“the Crestor® card”) is swiped and the 0220 code, which is the code for Nexium® medication in 20 mg doses, 5 capsule amounts, as shown in codes 402d of card 402 (“Nexium® card”), is input by the card user, the SSOS may indicate an error message, for example using the POS device, and not provide the ordered capsules.

In addition, the illustrated example cards 401-404 of FIG. 4 also include one or more codes to initiate contact with a representative, whether of the entity providing the SSOS or a representative of the manufacturer. For example, on the bottom of the cards, the codes “411” and “911” correspond to a request and an urgent request for contact by a representative, respectively. The codes are exemplary and other codes may be utilized in other embodiments. In addition, there may be separate codes for different manners of contact, such as by telephone, video conference, instant messaging, or email. Similarly, some codes may also indicate a specific time for the contact (e.g., call at 4 p.m.). In addition, in at least some embodiments a custom toll-free number printed on the cards may be called for assisting with using the SSOS.

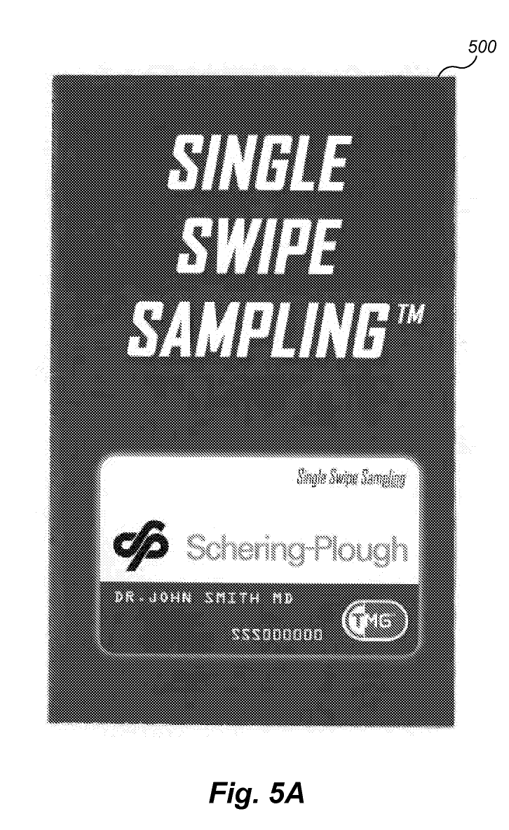

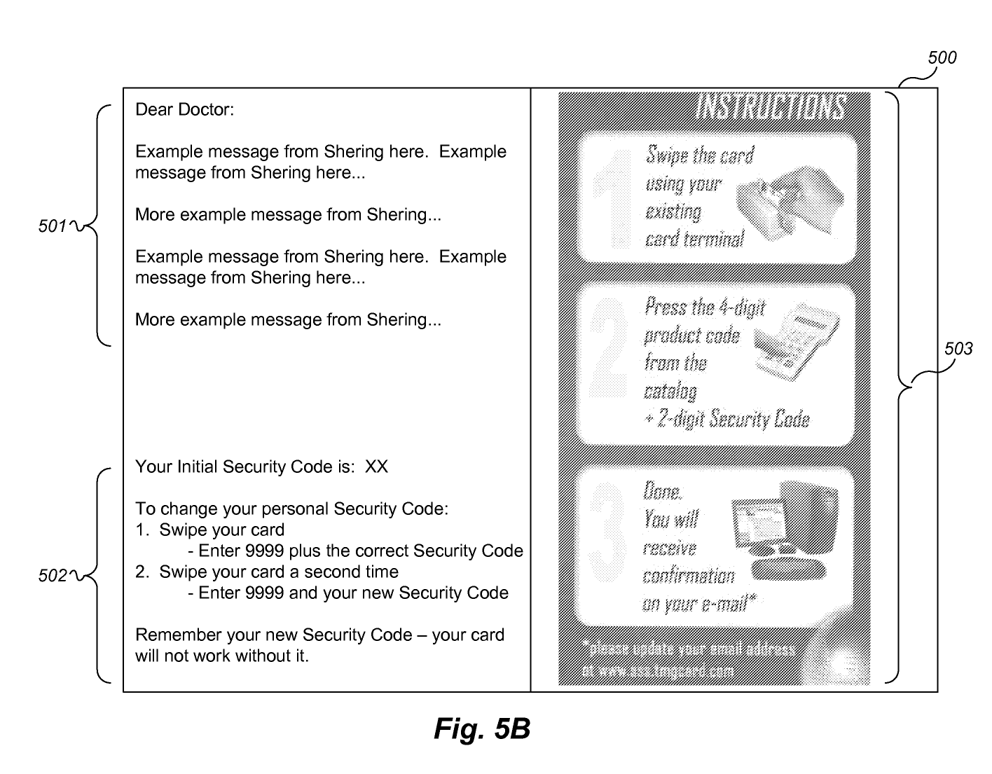

FIGS. 5A-5B illustrate a card mailer used in an example embodiment. In particular, FIGS. 5A-5B illustrate a card mailer 500 that includes a message 501 to a user (e.g., a physician) and instructions 502 and 503 to the physician for ordering samples and performing maintenance tasks of a particular product. In this example, the card mailer 500 has been customized for a particular pharmaceutical manufacturer (Schering-Plough). With instructions 503, the mailer 500 instructs the physician on use of the card to order samples. With instructions 502, the mailer 500 instructions the physician as to how to change the security code associated with the card. In other embodiments, some or all of the maintenance tasks associated with a card may be performed in other manners, such as online at an associated Web portal or by contacting a customer service representative.

Referring back to FIG. 3, in typical operation, a single swipe card is distributed subsequently to one or more card users 303 such as licensed healthcare professionals. Each card can then be activated and used like a standard credit or debit card by the card users 303. For example, once activated, the healthcare professional swipes the card in a POS device, keys in information regarding which sample is desired (e.g., a product code) and identifying information of the professional. This information is used by systems of the non-financial transaction entity 301 to process the order, approving or denying the transaction. The financial transaction processor 304 receives this information over a financial network (e.g., a secure financial network), and forwards such information to one or more systems associated with the non-financial transaction entity 301 to approve or deny the transaction. Once approved, information corresponding to the order is forwarded to a fulfillment center 305 to fulfill the order.

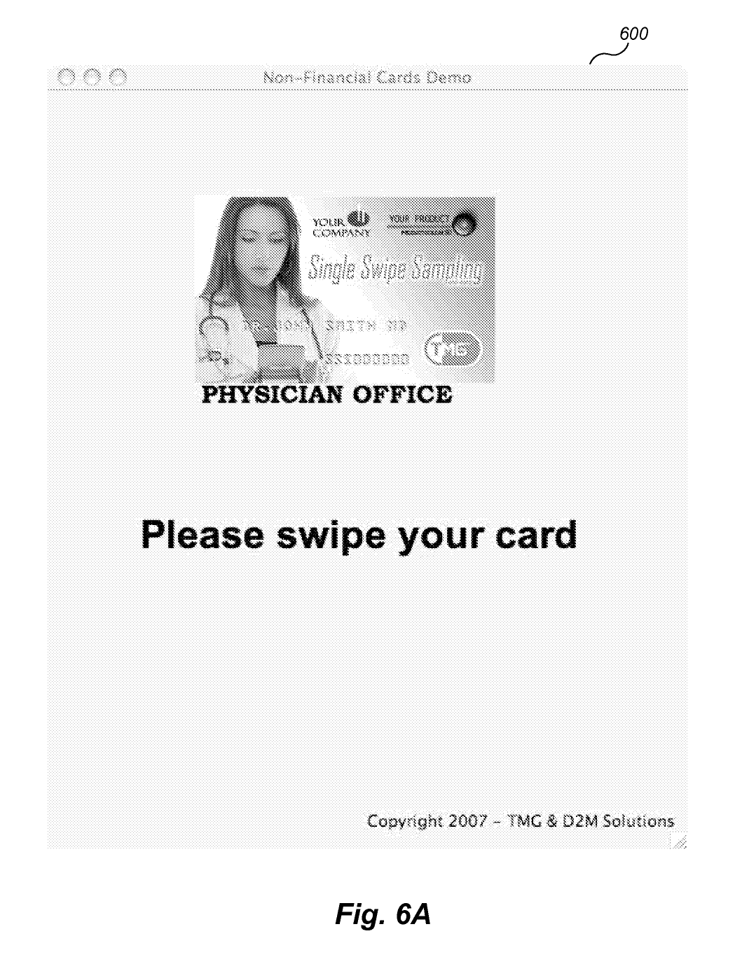

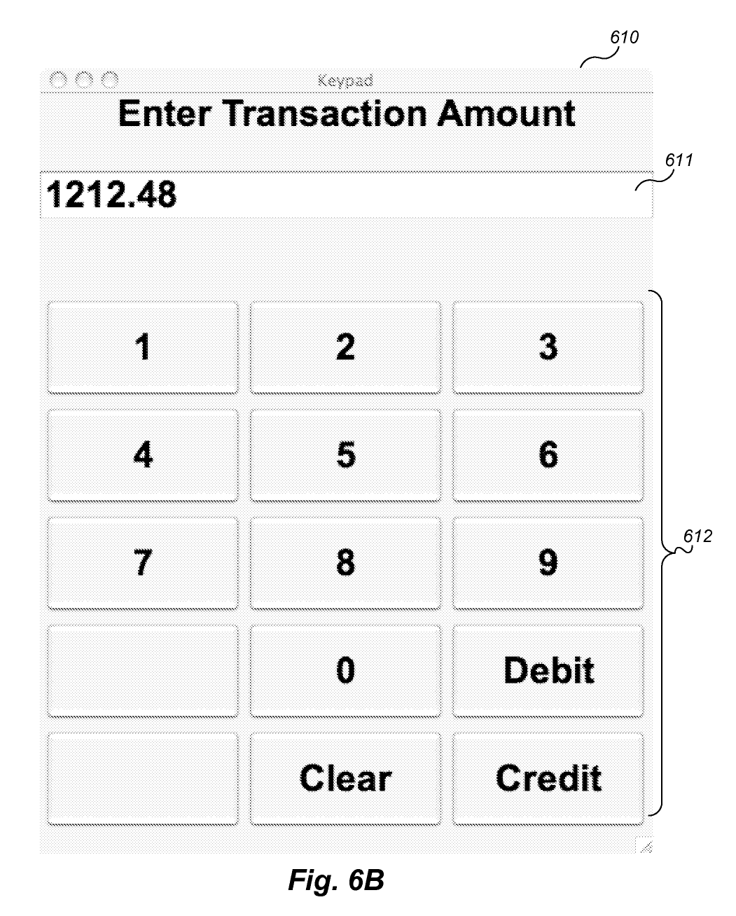

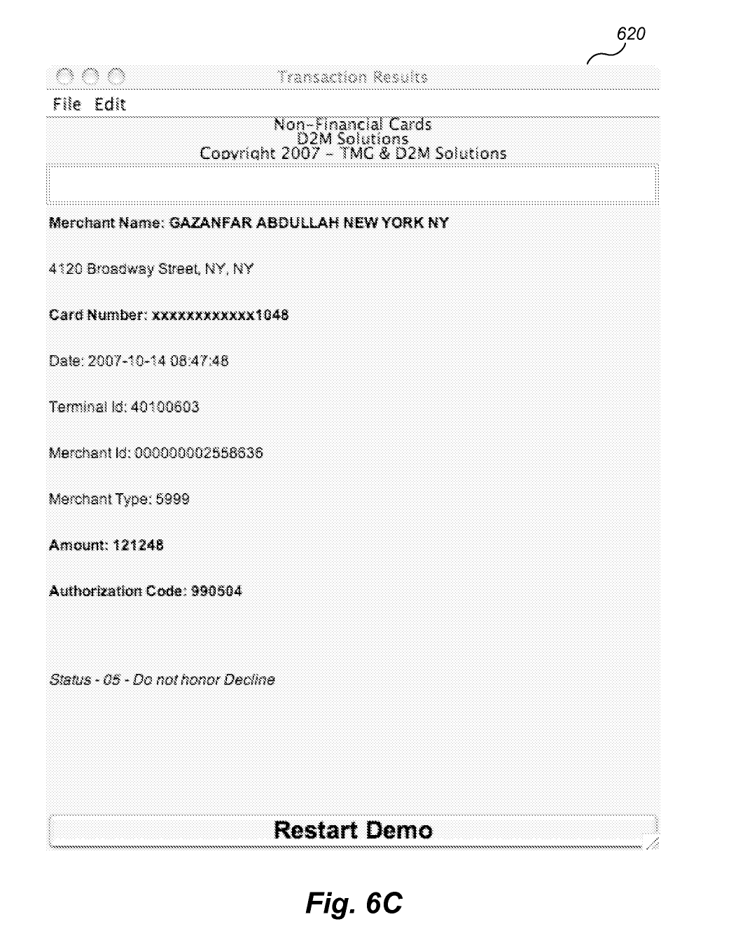

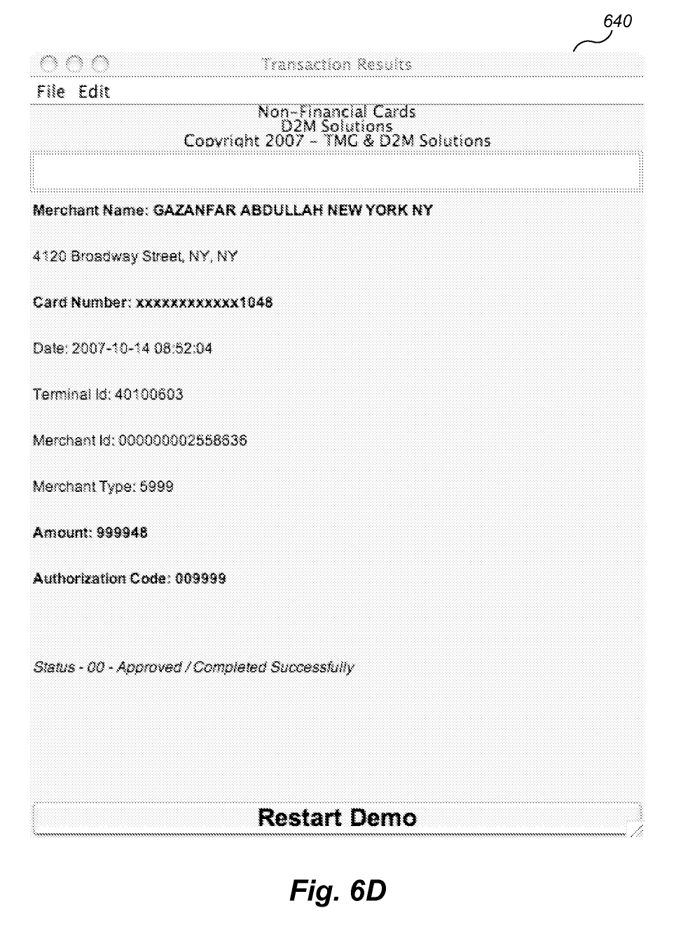

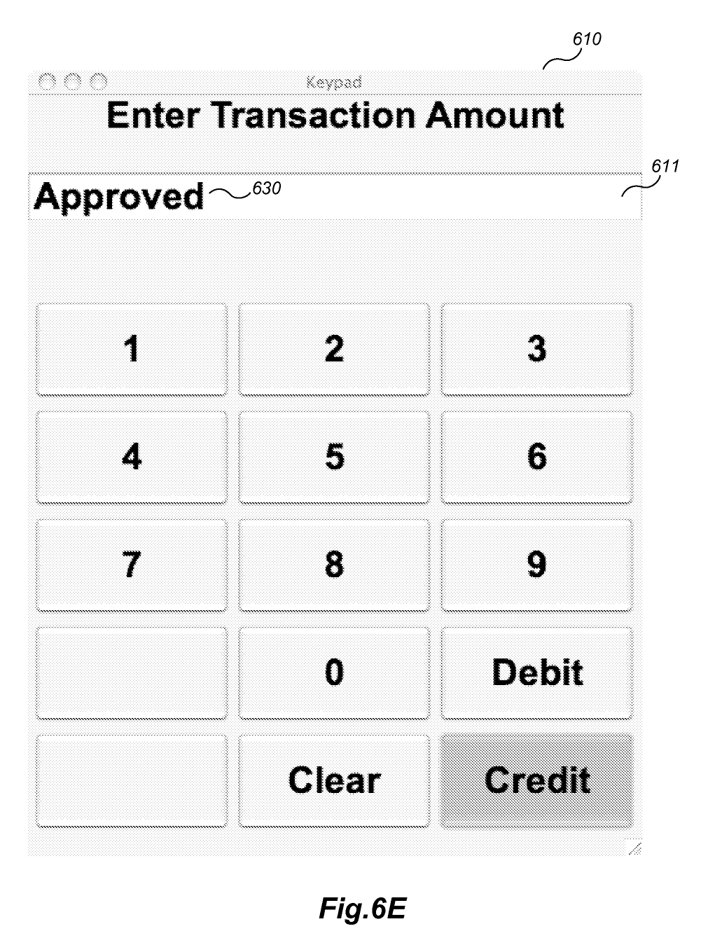

FIGS. 6A-6E illustrate use of an example embodiment with a point-of-sale device for a non-financial transaction. FIGS. 6A-6E show the types of records that are generated in response to a swipe of a card in a point-of-sale device, and the approved or denied notification provided to the user on the point-of-sale device.

In particular, FIG. 6A illustrates a welcome screen 600 that may be displayed on a display associated with an example point-of-sale device. The welcome screen 600 instructs the user to begin a transaction by swiping her card.

FIG. 6B illustrates an example point-of-sale device 610. The point-of-sale device 610 includes a display screen 611 and a keypad 612. In this example, the user has swiped her card and entered an item code identifying a product to be delivered along with the user's security code. The item and security code are entered in a manner similar to entering a sale amount for a financial transaction. In this example, the digits “1212” are the product code, and the digits “48” are the user's security code. Different point-of-sale devices may use alternative known techniques for entering and/or displaying information in the course of a particular transaction.

FIG. 6C illustrates a transaction record 620 generated in response to an example input at the point-of-sale device. The transaction record 620 may be provided by, for example, a non-financial transaction processor. The transaction record 620 includes multiple entries that describe the transaction, including the merchant (user) name, the merchant address, a card number, a transaction date, a terminal identifier, a merchant identifier, a merchant type identifier, a transaction amount, an authorization code, and a status code. Here, the product code and security code entered as a “sale amount,” as described in FIG. 6B are represented as the transaction amount. In this case, the status code indicates that the transaction has been declined. The transaction may have been declined for various reasons, including an expired card, an excessive order quantity, an unauthorized drug, etc.

FIG. 6D illustrates another transaction record 640 generated in response to an example input at the point-of-sale device 610. The transaction record 640 is similar to the transaction record 620 described with reference to FIG. 6C, except that the transaction record 640 includes a different transaction amount, authorization code, and status code. From the record 620, it can be seen that the product code entered was “9999” with a security code of “48.” In this case, the status code indicates that the transaction has been approved and completed successfully.

FIG. 6E illustrates a notification received at the point-of-sale device 610. In FIG. 6E, the example transaction of FIG. 6D has been approved, and the user is notified of that fact via a message 630 (“Approved”) displayed in the display screen 611.

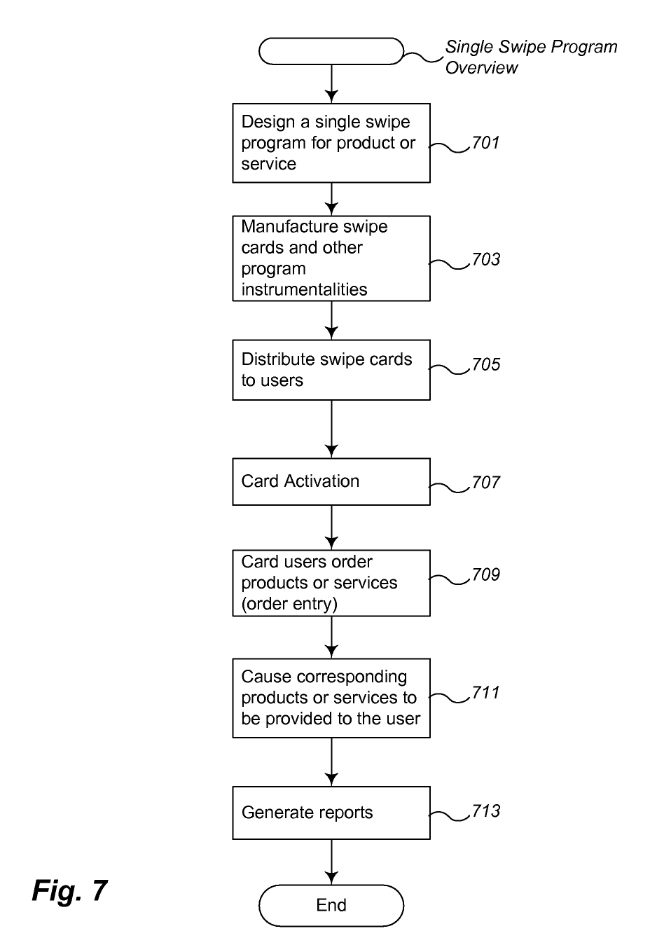

FIG. 7 is an example flow diagram that overviews a process for providing a product or service obtainment program that operates according to an example Single Swipe Obtainment System. For example, this process may be used by the components shown in FIG. 3 to provide a single swipe sampling program.

The process begins in block 701, where a single swipe program is designed for delivering a product and/or service, as described above. Designing a single swipe program may include, for example, customizing cards for a particular single swipe program, as described above.

In block 703, swipe cards appropriate for the program are manufactured or otherwise instrumented. The cards may resemble a footprint of credit or debit cards and typically contain a unique identifier (a card ID) encoded on a magnetic strip on the back of the card, although other machine-readable payment media may be used in other embodiments. In some embodiments, the card ID may be embossed on the front of the card, potentially with the name of the intended card user. In at least some embodiments, the unique identifier used to identify the card for performing a financial transaction is not embossed on the card. The card may also have an identified expiration date embossed, or otherwise encoded thereon.

In block 705, the swipe cards are distributed to card users, such as to the healthcare professionals described above. The cards may be distributed in various manners, such as via mail or sales representative. Once the card is acquired by a card user, such as the healthcare professional, then in block 707 the healthcare professional activates the card. The card may be activated online and/or over the phone (e.g., using Interactive Voice Response (“IVR”) or Caller ID-based activation) and may include, for example, supplying contact information (e.g., a mailing address and/or a telephone number) for the healthcare professional and/or information used for security or verification purposes (e.g., information regarding the healthcare professional's medical license, an identifier of an existing POS terminal in the healthcare professional's office, etc.). After activating the card, the healthcare professional is provided a user specific security code, for example by the SSOS.

In other embodiments, pre-activated cards with security codes are supplied to the card users. For example, each card may be assigned to a physician or other healthcare professional at a given location. The magnetic strip on the back of the card may have encoded thereon specific information used to securely identify the physical, pharmaceutical manufacture, etc.

In block 709, the card user orders a product or service using the activated card. For example, when the healthcare professional wants to order pharmaceutical samples, the healthcare professional swipes the card on a receiving device, such as an existing point-of-sale terminal in the healthcare professional's office. After swiping the card, the healthcare professional enters one or more codes associated with a product or service and the security code known only to the healthcare professional. For example, in order to emulate a credit or debit card transaction, a product code may be entered as the amount of the transaction and the security code as the PIN. In other embodiments, both codes may be entered as the six or seven digits typically reserved for a transaction amount, as shown in FIGS. 6A-6E. The codes are subsequently transmitted via a financial transaction network to whichever processing entity is providing the SSOS (e.g., a non-financial entity or an entity associated with the financial institution that issued the card). Other information may be automatically transmitted to the processing entity as well, such as the unique identifier of the card and an identifier of the point-of-sale terminal.

In block 711, the ordered product or service is caused to be provided, for example to the card user that initiated the swipe transaction or to someone associated with or designated by the card user. For example, under the control of a non-financial entity 301, the products and/or services associated with the transmitted code are determined as well as the identity of the requester. The identity of the requester may be determined by verifying the security code supplied with the security code associated with the card, for example, as stored in a data repository associated with the SSOS. Advantageously, the two-factor authentication of having the physical card and knowing the security code may aid in regulatory compliance. Further, the SSOS may produce time-stamped logs of various transactions to provide an audit trail. Assuming the identity of the requester is verified, the SSOS initiates the providing of the ordered product or service to the card user, for example, the providing of samples to the designated health care professional. For example, the order may subsequently sent to a fulfillment center, such as fulfillment center 305 to cause the sample to be sent via mail or private carrier to the healthcare professional's address. In other embodiments, the product or service may be provided in other manners, such as by a visit from a pharmaceutical company's sales representative. In at least some embodiments of an SSS program, a confirmation email is sent to the healthcare professional, to indicate that the pharmaceutical sample will be sent, while in other embodiments a message may be indicated on the POS terminal or on some other device designated for such purpose, such as a phone, PDA, etc., associated with the healthcare professional.

In block 713, various reports optionally may be generated based on the logged transactions. Such reports may be used, for example, for regulatory reporting, marketing and/or accounting purposes. The overall process for providing a requested product and/or service is then complete. For example, once the pharmaceutical samples are received by the healthcare professional, the healthcare professional may further distribute the samples to the healthcare professional's patients when appropriate.

With respect to the distribution of pharmaceutical samples to healthcare professionals, the SSOS advantageously reduces the need for a sales force, or at least helps manage associated costs and efficiencies, by transforming the distribution of samples from sales representatives to fulfillment centers. Also, because such samples are distributed based upon approved and track-able schedules (e.g., amount and frequency) and recipients, regulatory compliance is enhanced, and less over sampling preferably will occur. In addition, a level of service can be provided that is uniquely tailored to each healthcare professional, while simplifying the time and process needed to request samples.

Also, as mentioned, one or more items may be provided to the healthcare professional in other manners than shipping the product to the professional via the mail or private carriers. For example, in some embodiments, the professional may pick up the product from inventory at a local location, the product may be shipped to a local store or warehouse, the product may be delivered by a sales representative, or the product may be sent electronically (e.g., for a software product or audiovisual work), etc. In some embodiments, an additional digit or digits may be added to the code to indicate a preferred method for providing the product or service. In addition, depending on the nature of the product or service, the security code may be optional for some or all of the products or services, such as not needing the security code for a representative to contact the professional.

Furthermore, users other than healthcare professionals may receive a card and swipe it to receive a product or service. For example, a single swipe card may be used to order promotional items at a trade show. In addition, other professionals, such as police officers, financial advisors, or tradesman, may be users of an SSOS. In some embodiments, the SSOS may be used within an enterprise to order highly-regulated products from one or more of the enterprise's warehouses. For example, a retail pharmacy may use an embodiment of the SSOS to order pharmaceutical compositions from one of their warehouses so that the SSOS can assist in tracking the distribution of the pharmaceutical compositions.

In addition, although as described the products or services are ordered without payment via the financial transaction network, in at least some embodiments the products or services are not gratuitously supplied. For example, the product may have been previously purchased on behalf of the user with delivery delayed for logistical reasons, such as limited space at the user's location, the product being perishable, or for regulatory reasons (e.g., mandated accounting for the product throughout its distribution). In other situations, a business relationship may exist between the supplier and the user receiving the product or service so that the user (or an entity the user is affiliated with) will be subsequently billed for the products or services provided. In such embodiments, the SSOS may determine whether payment is available before providing the products or services. Other permutations can be similarly accommodated.

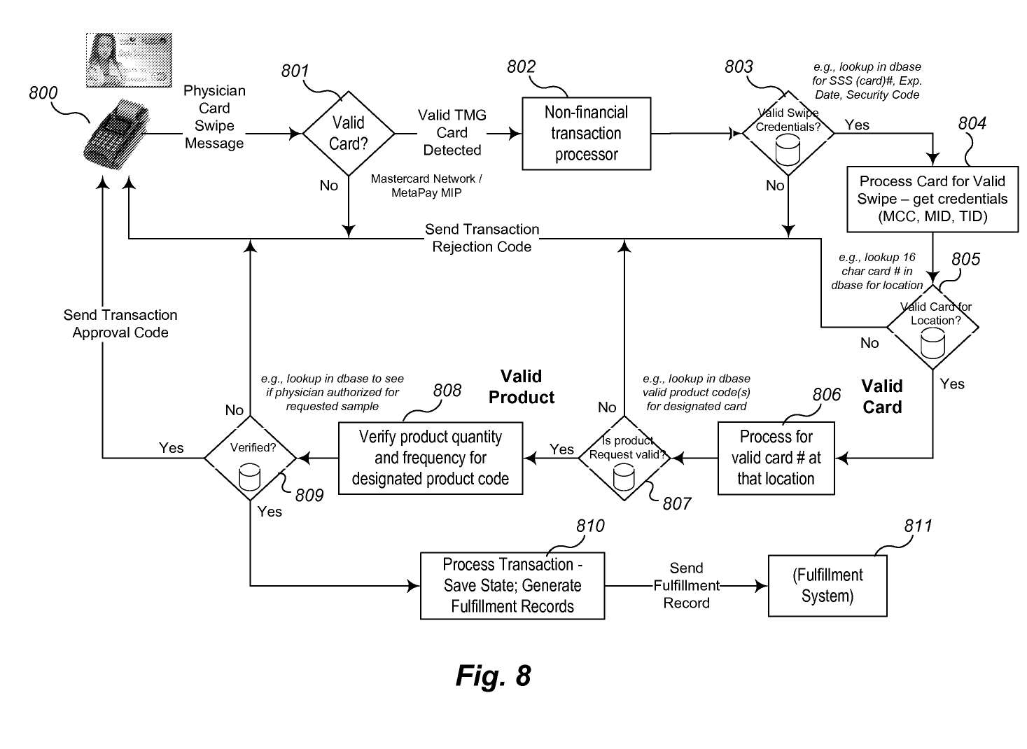

FIGS. 8-13 illustrate an example embodiment of an SSOS used to provide single swipe sampling programs to pharmaceutical manufactures and the like.

FIG. 8 is an example flow diagram that illustrates process flow through an example embodiment of the Single Swipe Obtainment System. In particular, FIG. 8 illustrates details of process flow through the SSOS in response to a card being swiped at a healthcare professional's office.

In step 800, a user, such as a physician or other healthcare professional, swipes a card at a point-of-sale terminal. In other embodiments, the user may indicate card use in other ways, such as by placing the card near an RFID (“Radio Frequency Identifier”) reader, bar code scanner, etc.

In step 801, a financial transaction processor that is associated with the point-of-sale terminal determines whether the card is valid, and if so, transmits an indication that a valid card was swiped to a non-financial transaction entity and proceeds to step 802, else transmits a transaction rejection code to the point-of-sale terminal and returns to step 800.

In step 802, the indication that a valid card was swiped is received by the non-financial transaction processor. In addition, the non-financial transaction processor may receive, from the financial transaction processor, additional information about the transaction and/or the swiped card, such as card number, card holder name, expiration date, security code, product code (e.g., specifying the item and/or quantity ordered), etc.

In step 803, the non-financial transaction processor determines whether the card credentials are valid. Determining whether the card credentials are valid may include looking up the expiration date and/or security code in a card data repository. If the card credentials are determined to be valid, the routine proceeds to step 804, else it transmits a transaction rejection code to the point-of-sale terminal and returns to step 800.

In step 804, the non-financial transaction processor processes the card for a valid swipe. Processing a valid swipe may include obtaining various additional information about the transaction, such as the location of the point-of-sale terminal, user information, transaction identifier, etc. This information may be stored or otherwise recorded in a data repository for further processing, as described below.

In step 805, the non-financial transaction processor determines whether the card is valid for a specified location. In some embodiments, cards may be limited for use in particular geographic locations, for purposes such as fraud prevention and/or the maintenance of distributor relationships, such as when particular distributors have distribution rights in specific geographic locations. Determining the geographic validity of the card may include determining whether the location of the point-of-sale terminal is in a location (e.g., a city, state, zip code) that is approved for use of the card. If the routine determines that the card is geographically valid, the routine proceeds to step 806, else it transmits a transaction rejection code to the point-of-sale terminal and returns to step 800.

In step 806, the non-financial transaction processor processes the card for a valid swipe at the specified location. Processing the card for a valid swipe at the specified location may include recording an indication of this fact in a data repository.

In step 807, the non-financial transaction processor determines whether the product request is valid. As discussed above, a card may be associated with particular products, such that the user of the card may be entitled to order only those products. Thus, determining whether the product request is valid may include determining, from the received product code, whether the requested product is one of the products associated with the card. If the routine determines that the product request is valid, the routine proceeds to step 808, else it transmits a transaction rejection code to the point-of-sale terminal and returns to step 800.

In step 808, the non-financial transaction processor verifies the ordered product quantity and frequency for the designated product code. In some embodiments, sampling rules may be used to place limits on the frequency of card use and/or the quantity of products ordered with a particular card. Thus, verifying the ordered product quantity may include determining whether the ordered product quantity is less than or equal to one or more quantity limits associated with the card, such as a per-order limit (e.g., a maximum number of samples per order), per-time limit (e.g., a maximum number of samples per day, week, month, year, etc.), lifetime limit (e.g., a maximum number of samples for the lifetime of the card), etc. In addition, verifying the ordered product frequency may include determining whether order frequency, as based on a historical record of orders, is below a threshold order frequency associated with the card, such as five orders per day, 20 orders per month, etc.

In step 809, the non-financial transaction processor determines whether the order was verified in step 808, and if so, transmits a transaction approval code to the point-of-sale terminal and proceeds to step 810, else transmits a transaction rejection code to the point-of-sale terminal and returns to step 800.

In step 810, the non-financial transaction processor processes the transaction and sends a fulfillment record to a fulfillment system. Processing the transaction may include storing information about the transaction in a data repository (e.g., date and time of the transaction, transaction success codes, transaction identifiers, etc.). Processing the transaction may also include generating a fulfillment record, such as an electronic order detailing the product type, product quantity, recipient, etc. This fulfillment record may then be forwarded to the fulfillment system.

In step 811, the fulfillment system fulfils the order. Fulfilling the order may include packaging the order and shipping the packaged order to the recipient of the order.

The process described with respect to FIG. 8 provides various advantages. For example, a third party, such as a non-financial transaction entity, can process transactions using financial network-based point-of-sale devices. Because such point-of-sale devices are widely deployed and understood by their users, the third party can leverage existing financial processing infrastructure without making substantial capital investments to deploy new equipment, train users, etc. Furthermore, card processing can be performed in substantially real time, providing the third party with accurate, up-to-date information regarding product use and distribution. In addition, complex business rules can be employed by the non-financial transaction processor to validate cards on a per-swipe basis, so as to more closely regulate, control, and/or track the distribution of various products. Also, such a process provides fast response times to both users and the third party, thereby providing users with rapid feedback regarding the success and/or failure of their requests. In addition, the process may be readily scaled as additional end users and/or programs are added.

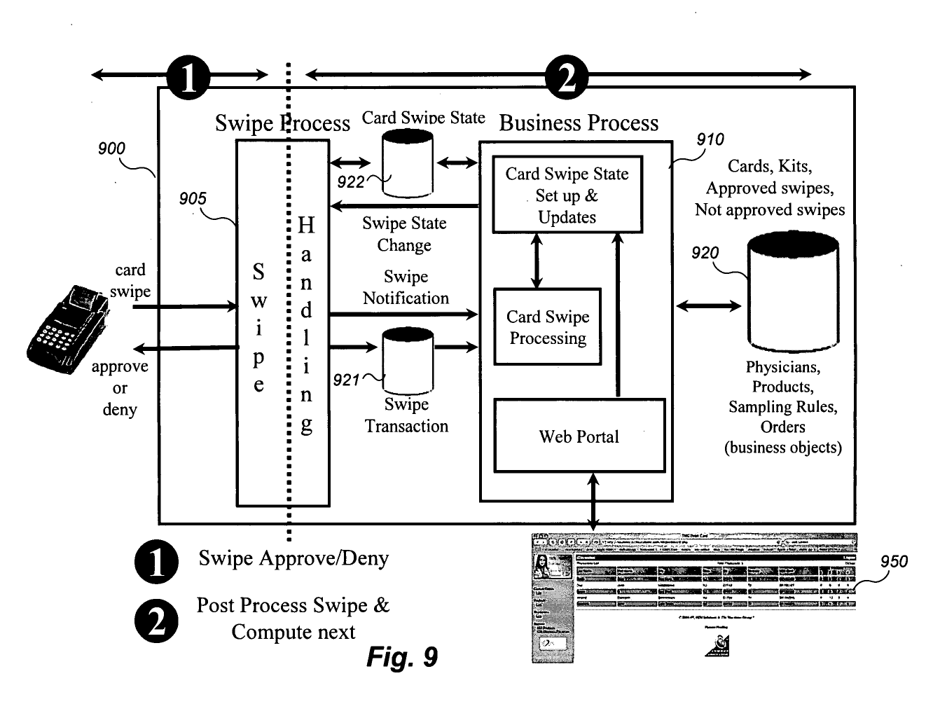

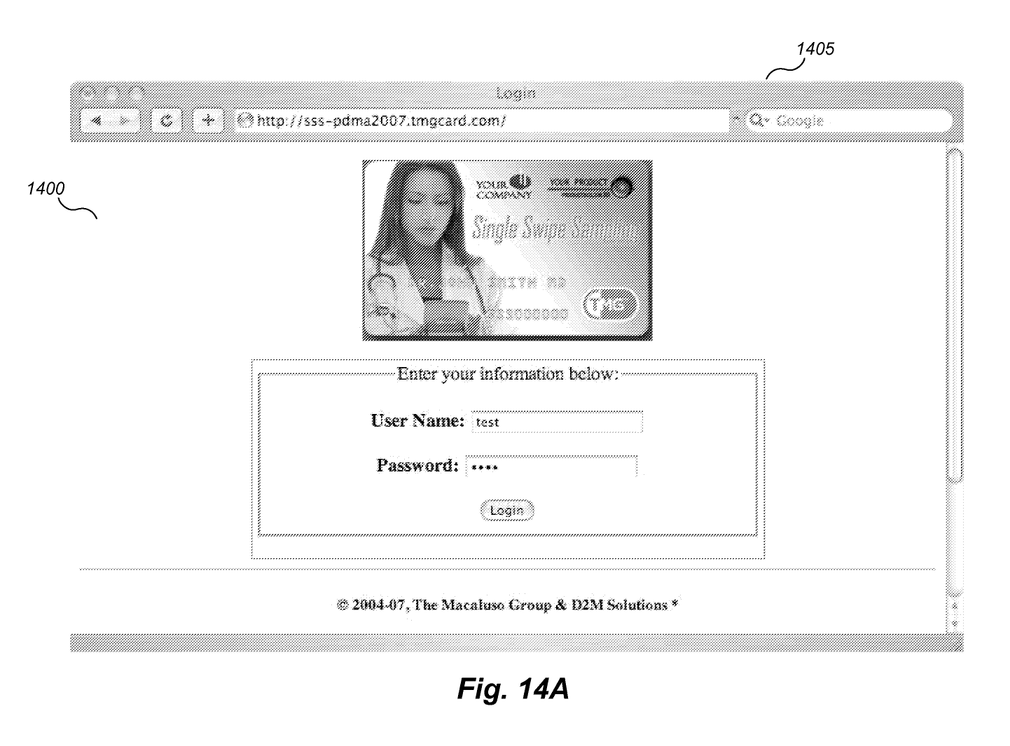

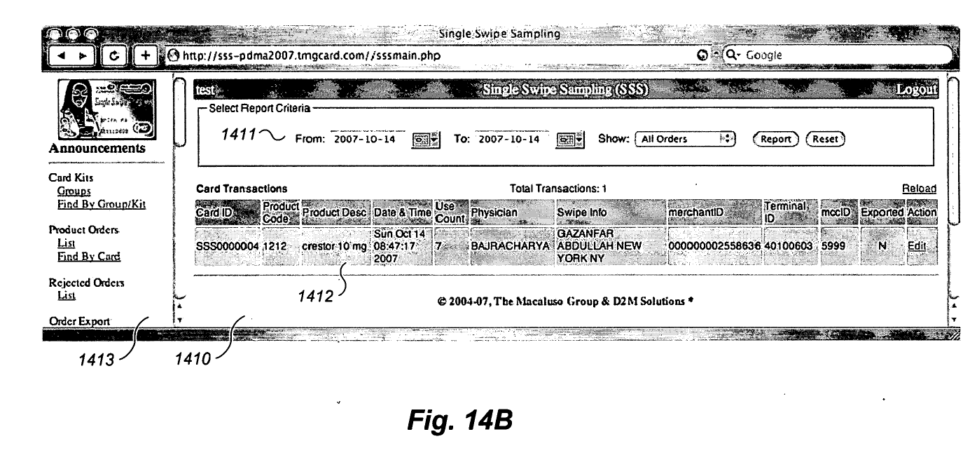

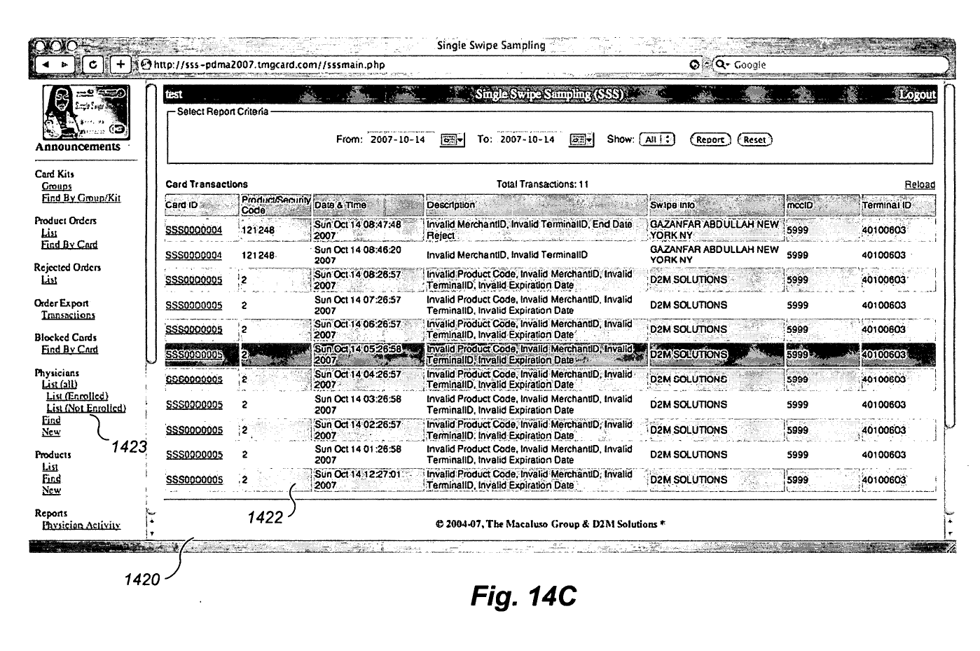

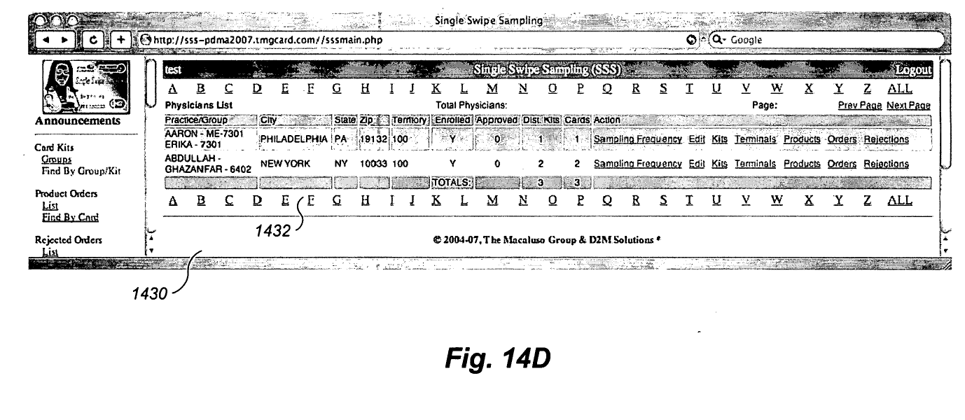

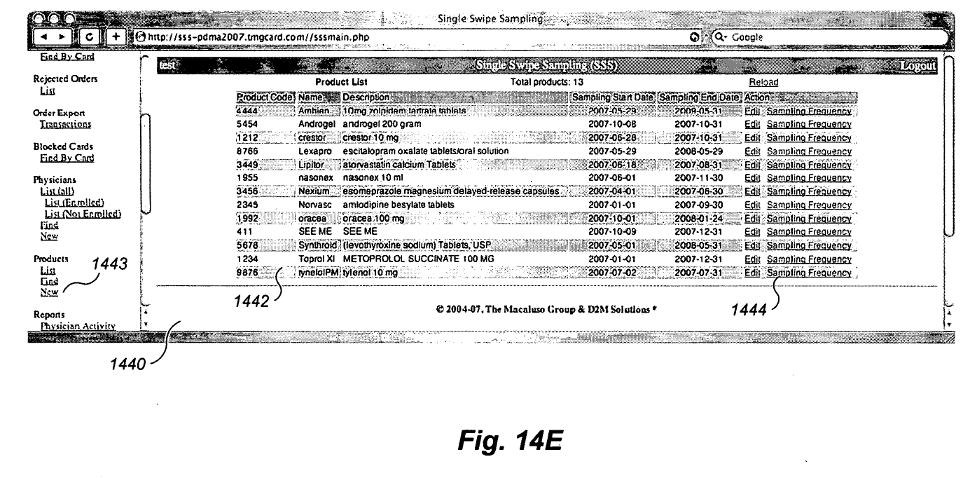

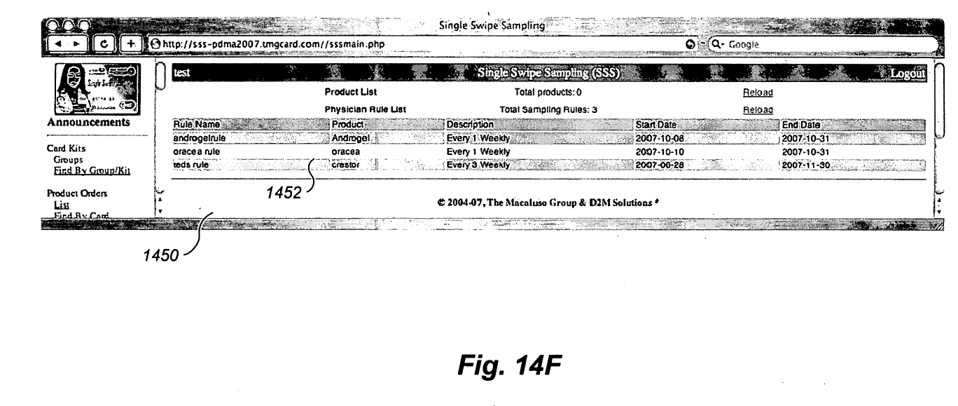

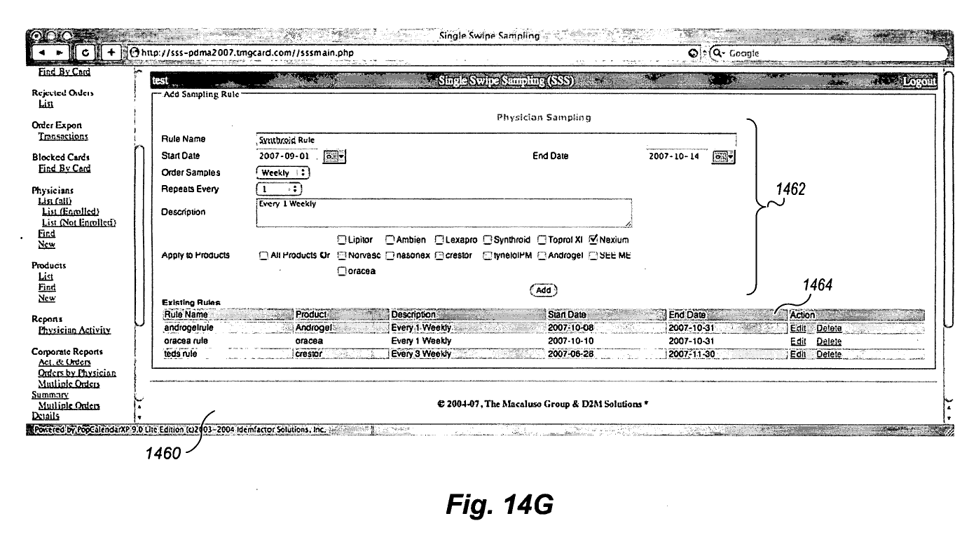

FIG. 9 is an example block diagram illustrating transaction processing performed by an example embodiment. In particular, FIG. 9 illustrates a Single Swipe Obtainment System 900 that includes a swipe processing engine 905, a business rules processing engine 910, a business objects data repository 920, a swipe transaction data repository 921, and a card swipe state data repository 922. The illustrated SSOS 900 is configured to process (accept/deny) swipes, generate orders to be fulfilled, and maintain a current card state for each transaction in near real-time, with typical responses to a swipe available in a few seconds (e.g., under 5 to 10 seconds). The business rules processing engine 910 manages business rules in a flexible and extensible system, which, in some embodiments, can be altered while the SSOS 900 is in operation. In the illustrated embodiment, these business rules are stored in the business objects data repository 920. In addition, the business objects data repository 920 may store information about cards, card kits, card swipe history (approved/denied swipes), physicians, products, sampling rules, and/or orders. Also, in the illustrated embodiment, the business rules processing engine 910 includes a Web portal that provides users (e.g., administrative users who manage card programs) with functions to access, supplement, and alter the business rules. An example Web portal is described in more detail with respect to FIGS. 14A-14G.

Furthermore, the SSOS 900 may record information about specific cards in the card swipe state data repository 922. In particular, the data repository 922 may include a card swipe state record (or other data structure) for each card processed by the SSOS 900. Data synchronization problems may be eliminated by maintaining an up-to-date card swipe state ahead of each swipe occurrence, which may be quickly compared during a swipe transaction. In some embodiments, card state can be represented as a unique vector for each possible state for each card. Furthermore, this state may be stored in memory, where it can be quickly accessed (e.g., for comparison purposes) when transaction data is received.

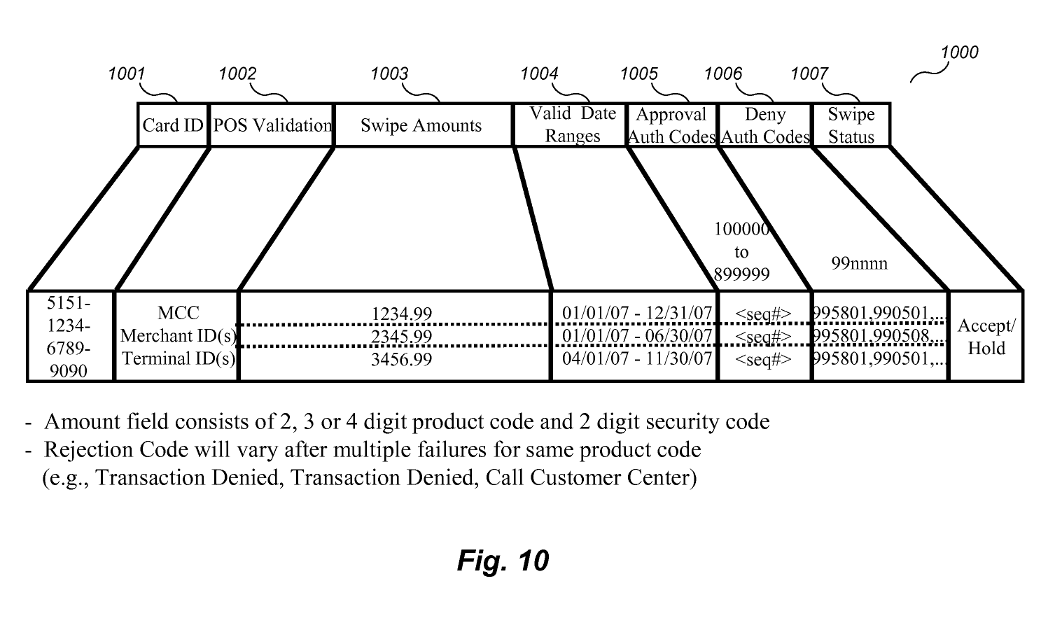

FIG. 10 illustrates one example of a card swipe state data structure utilized by an example embodiment of a Single Swipe Obtainment System. As illustrated, each swipe state of each card may be represented as a vector. Thus, translation of a card's state after processing a swipe may be performed quickly. Other equivalent data structures may be used and may be stored differently. FIG. 10 illustrates a card swipe state record 1000 for a single card comprising a card identifier (“ID”) field 1001, a point-of-sale validation field 1002, a swipe amounts field 1003, a valid dates field 1004, an approval codes field 1005, a denial codes field 1006, and a swipe status field 1007. The point-of-sale validation field 1002 may include one or more identifiers associated with the physician and/or particular point-of-sale hardware utilized by the physician, including a merchant category code (“MCC”), a merchant identifier, and a terminal identifier. The point-of-sale validation field 1002 may be utilized to determine that a card is being swiped from a terminal associated with an authorized physician.

In the illustrated embodiment involving drug samples, the swipe amounts field 1003 may include one or more swipe amounts that are digit sequences used to represent, in this particular example, particular drug samples. For example, the first four digits (to the left of the decimal point) may represent a particular drug, while the last two digits (to the right of the decimal point) may represent a security code. Other example embodiments may divide the digits in the swipe amounts field 1003 differently. In addition, each swipe amount has corresponding valid dates, approval authorization codes, and/or denial authorization codes, represented in the valid dates field 1004, approval codes field 1005, and denial codes field 1006, respectively. The valid dates field 1004 may include a date range that represents a time period during which a particular drug sample may be ordered. The approval codes field 1005 may include one or more approval codes that are transmitted in response to an approved transaction for a particular drug. The denial codes field 1006 may include one or more denial codes that are transmitted in response to an unauthorized transaction for a particular drug. In one embodiment, the denial codes may vary, such that multiple failed transactions result in specific actions begin taken, such as a customer service center being notified of suspicious account activity.

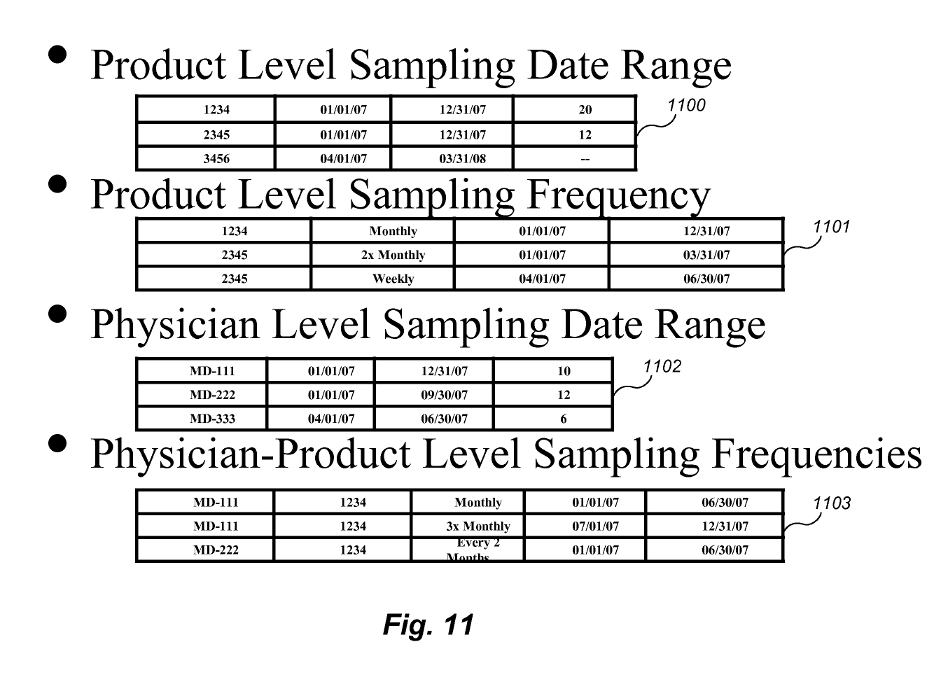

FIG. 11 illustrates example business rules utilized by an example embodiment. As noted above, some embodiments of the SSOS may employ business rules such as sampling rules to regulate the number of samples ordered with a particular sampling card. These business rules may be defined, stored, and managed in one place, such as the business objects data repository 920 of FIG. 9. FIG. 11 illustrates various example approaches to sampling rules, which may be used singly or in any combination. In particular, FIG. 11 illustrates a product level sampling date range table 1100, a product level sampling frequency table 1101, a physician level sampling date range table 1102, and a physician-product level sampling frequency table 1103. In some embodiments, sampling rules may be defined and/or represented using a calendar event metaphor, where samples may be obtained on a periodic, reoccurring basis, such as daily, weekly, monthly, etc. FIG. 14G illustrates an example of a calendar-like interface that may be utilized to define sampling rules.

The product level sampling date range table 1100 specifies, on a product-by-product basis, a maximum number of samples of a particular product that may be ordered during a specified time period. The table 1100 includes, for each product, a product identifier, a begin date, an end date, and a maximum order number. Thus, the top row of table 1100 may be interpreted to mean, for example, that product 1234 may be ordered a maximum of 20 times between Jan. 1, 2007 and Dec. 31, 2007.

The product level sampling frequency table 1101 specifies, on a product-by-product basis, a maximum frequency that a particular product may be ordered during a specified time period. The table 1101 includes, for each product, a product identifier, an order frequency, a begin date, and an end date. Thus, the top row of table 1101 may be interpreted to mean, for example, that product 1234 may be ordered at most once per month between Jan. 1, 2007 and Dec. 31, 2007.

The physician level sampling date range table 1102 specifies, on a physician-by-physician basis, a maximum number of samples that may be ordered during a specified time period. The table 1102 includes, for each physician, a physician identifier, a begin date, an end date, and a maximum order number. Thus, the top row of table 1102 may be interpreted to mean, for example, that physician MD-111 may order at most 10 samples of any drug between Jan. 1, 2007 and Dec. 31, 2007.

The physician-product level sampling frequency table 1103 specifies, on a physician-by-physician basis, a maximum frequency that a particular product may be ordered during a specified time period. The table 1103 includes, for each physician, a physician identifier, a product identifier, an order frequency, a begin date, and an end date. Thus, the top row of table 1103 may be interpreted to mean, for example, that physician MD-111 may order samples of product 1234 at most once per month between Jan. 1, 2007 and Jun. 30, 2007.

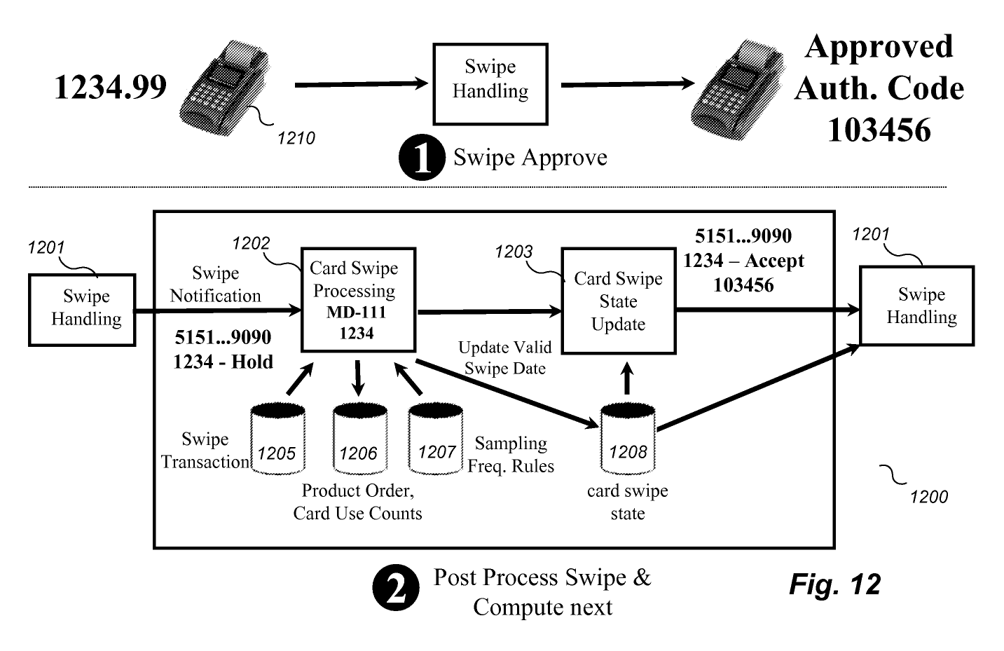

FIG. 12 illustrates an example process for handling an approved swipe provided by an example embodiment. In particular, FIG. 12 illustrates an SSOS 1200 that includes a swipe handling engine 1201, a card swipe processing engine 1202, a card swipe state update engine 1203, a swipe transaction data repository 1205, a product order and use count data repository 1206, a sampling rules data repository 1207, and a card swipe state date repository 1208. In the illustrated example, a transaction is initiated via a card swipe and corresponding data entry at a point-of-sale terminal 1210. The card swipe is initially processed by the swipe handling engine 1201, which notifies the card swipe processing engine 1202. The card swipe processing engine 1202 then determines, based at least in part on the contents of the data repositories 1205-1207, whether to approve or to deny the transaction. This determination may be based on whether the transaction is in accordance with one or more sampling (business) rules stored in the sampling rules data repository 1207. When the card swipe processing engine 1202 determines to authorize the transaction, it modifies the card swipe state that corresponds to the swiped card in an authorized state and that is stored in the card swipe state data repository 1208. Next, the card swipe state update engine 1203 transmits to the swipe handling engine 1201 an approval code that is based at least in part on the current card swipe state that is stored in the card swipe state data repository 1208.

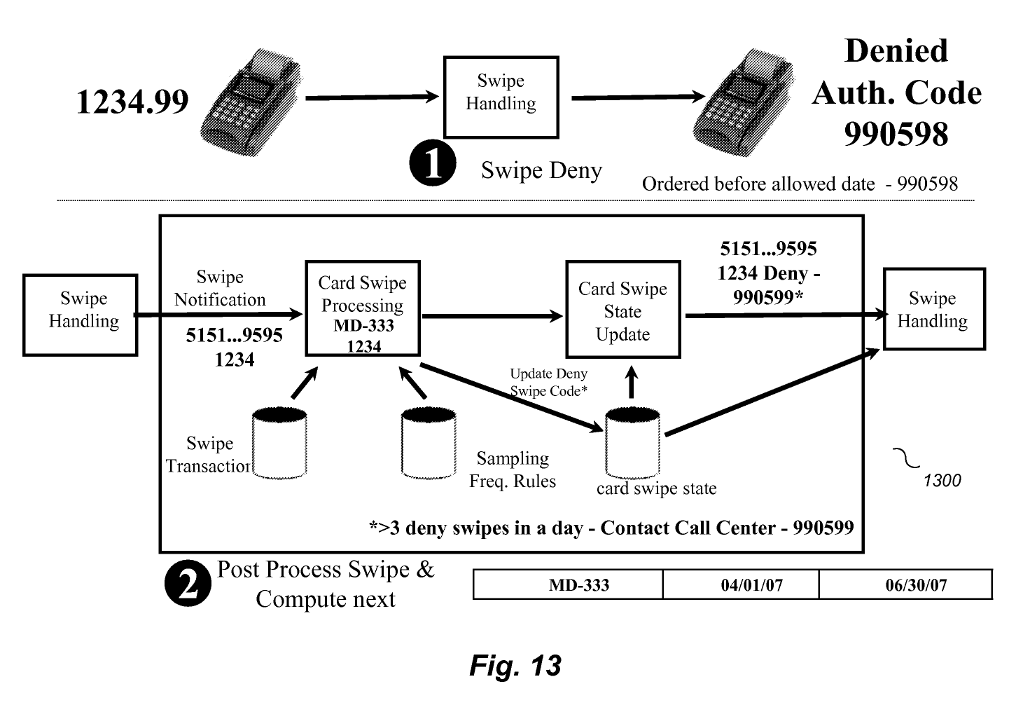

FIG. 13 illustrates an example process for handling a denied swipe provided by an example embodiment. In particular, FIG. 13 illustrates an SSOS 1300 that is similar to the SSOS 1200 described with respect to FIG. 12, above. The illustrated example differs from that of FIG. 12 in that the attempted transaction is denied by the SSOS 1300, based on the fact that an order is being attempted outside (e.g., before) of a time period during which orders for a particular sample are allowed. Accordingly, the SSOS 1300 generates and transmits a denial code to the swipe handling engine. In this case, the denial code indicates that multiple (e.g., more than three) denials have been processed for this particular card within a one-day period, and that a customer service center should be notified of possible unauthorized card use.

FIGS. 14A-14G illustrate an example Web portal for administering and communicating with a single swipe sampling program used to supply pharmaceutical samples. For example, such a portal may be used to interface to the processing systems described with reference to FIGS. 8-13. Various lists, such as a current product list, physician list, and product rules can be generated, viewed, and edited using the portal. Moreover, the portal interface shows the ability to define new business rules for the distribution of samples, which allows the SSOS to flexibly track requirements, such as external requirements imposed by regulatory considerations. In addition, current orders sent for fulfillment may be tracked, as well as orders that have been denied.

FIG. 14A is an example screen display of a login screen provided by the Web portal. In particular, FIG. 14A illustrates a login screen 1400 displayed in the context of a Web browser 1405. A user may enter a user name and password via the login screen 1400 in order to gain access to various functions of the Web portal.

FIG. 14B is an example screen display of a reporting screen provided by the Web portal. In particular, FIG. 14B illustrates a reporting screen 1410 that may be utilized by a user to generate a report regarding ordering activity (e.g., transactions) associated with one or more single swipe cards. Multiple controls 1411 may be utilized by a user to specify report criteria, including date ranges and/or order types. In response to a report generation request, a transaction report 1412 may be displayed. The illustrated transaction report 1412 describes a single transaction, by providing multiple fields of information, such as a card identifier (“ID”); a product code; a product description; a data and time; a use count; a physician name; swipe information, such as the geographic location of the card swipe; a merchant identifier; a point-of-sale terminal identifier; etc. Navigation area 1413 allows a user to navigate between different views of the transaction data sorted by various parameters and/or criteria.

FIG. 14C is an example screen display of another reporting screen provided by the Web portal. In particular, FIG. 14C illustrates a reporting screen 1420 that is similar to reporting screen 1410 described with reference to FIG. 14B. Reporting screen 1420 includes a transaction report 1422 that describes multiple transactions related to multiple different cards.

FIG. 14D is an example screen display of a physician information screen provided by the Web portal. In particular, FIG. 14D illustrates an information screen 1430 that includes physician data 1432. The physician data may be displayed, for example, in response to a user selection of an appropriate link in navigation area 1423 of FIG. 14C. The illustrated physician data 1432 describes two physicians, by providing multiple fields of information, including practice/group information, address information (e.g., city, state, zip code, etc.), enrollment status, number of cards received, etc. In addition, for each physician, controls (e.g., links, buttons, etc.) are provided that may be activated or selected by a user to perform various functions with respect to the physician, such as modifying information about the physician and/or the sampling program they are enrolled in (e.g., modifying sampling frequency, point-of-sale terminal information, recent orders, rejected orders, etc.).

FIG. 14E is an example screen display of a product information screen provided by the Web portal. In particular, FIG. 14E illustrates an information screen 1440 that includes product data 1442. The illustrated product data 1442 describes 13 products, by providing multiple fields of information for each product, including product code, product name, product description, sampling start and end dates, etc. In addition, for each product, controls (e.g., links, buttons, etc.) are provided that may be activated or selected by a user to perform various functions with respect to the product, such as editing one or more information fields, viewing and/or modifying sampling rules, etc. The product data 1442 may be displayed, for example, in response to user selection of an appropriate link in navigation area 1443.

FIG. 14F is an example screen display of a sampling rules information screen provided by the Web portal. In particular, FIG. 14F illustrates an information screen 1450 that includes sampling rules data 1452. The illustrated sampling rules data 1452 describes three sampling rules, by providing multiple fields of information about each rule, including rule name, associated product, rule description, rule start and end date, etc. The sampling rules data 1452 may be displayed, for example, in response to user selection of an appropriate control, such as the sampling frequency link 1444 of FIG. 14E.

FIG. 14G is an example screen display of a rule specification screen provided by the Web portal. In particular, FIG. 14G illustrates a rule specification screen 1460 that includes multiple controls 1462 that may be activated or selected by a user to generate a new sampling rule or modify an existing sampling rule. A given sampling rule may be associated with one or more products and/or physicians. The controls 1462 include a rule name input field, start and end date controls, a sampling frequency control, a rule description control, and product association controls (e.g., to apply the rule to one or more products). In addition, the rule specification screen 1460 includes existing rules data 1464 that is similar to the sampling rules data 1452 described with reference to FIG. 14F.

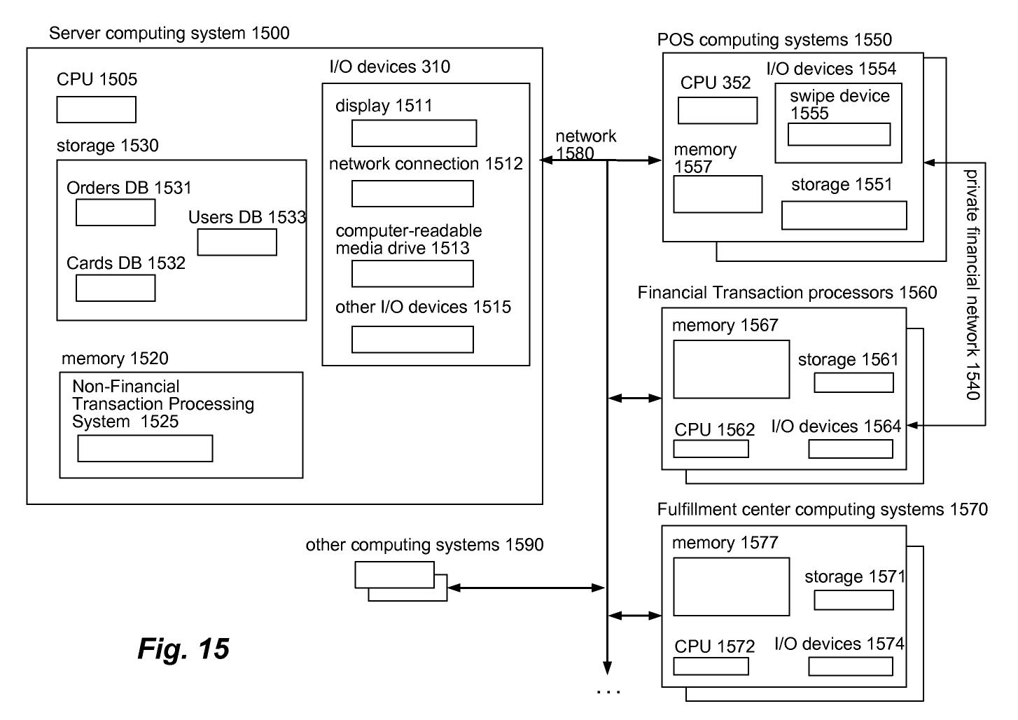

FIG. 15 is an example block diagram illustrating an example computing system suitable for executing embodiments of the Single Swipe Obtainment System. The illustrated computing system may comprise a general purpose or a special purpose computing system. In the embodiment shown, the computing system 1500 comprises one or more server computing systems 1500, one or more point-of-sale computing systems 1550, one or more financial transaction processors 1560, one or more fulfillment center computing systems 1570, and other computing system 1590, connected by one or more networks 1580. In addition, in typical embodiments, the point-of-sale computing systems 1550 are connected via a private network 1540 to the financial transaction processors 1560.

A server computing system 1500 for practicing embodiments of the non-financial transaction processing of an SSOS comprises one or more Central Processing Units (“CPU”) 1505; a computer memory (“memory”) 1520; input/output (“IO”) devices which may include a display 1511, a network interface 1512, a computer-readable media drive 1513, other I/O devices 1515; and other storage 1530, such as including orders, cards, and users data repositories 1531-1533. In any particular embodiment, one or more of these features or components may not be present. A non-financial transaction processing system (“NFTPS”, or non-financial transaction processor) 1525 is shown residing in the memory 1520. The components (not shown) of the NFTPS 1525 preferably execute on the one or more CPUs 1505. The NFTPS 1525 may include one or more components/modules described with respect to the non-financial transaction processors described with respect to FIGS. 9 and/or 16.

In an example embodiment, components of the an NFTPS 1525 are implemented using standard programming techniques. A range of programming languages known in the art may be employed for implementing an example embodiment of the NFTPS, including representative implementations of various programming language paradigms, including, but not limited to, object-oriented (e.g., Java, C++, C#, Smalltalk), functional (e.g., ML, Lisp, Scheme, etc.), procedural (e.g., C, Pascal, Ada, Modula, etc.), scripting (e.g., Perl, Ruby, Python, JavaScript, VBscript, etc.), (declarative (e.g., SQL, Prolog, etc.), etc. In addition, the various components of the NFTPS 1525 may be implemented by way of a single monolithic executable running on a single CPU computer system, or alternately decomposed using a variety of structuring techniques known in the art, including, but not limited to, multiprogramming, multithreading, client-server, or peer-to-peer, running on one or more computer systems each having one or more CPUs.

The embodiments described above use well-known or proprietary synchronous or asynchronous client-sever computing techniques. However, the various components may be implemented more monolithic programming techniques as well, for example, an executable running on a single CPU computer system, or alternately decomposed using a variety of structuring techniques known in the art, including but not limited to, multiprogramming, multithreading, client-server, or peer-to-peer, running on one or more computer systems each having one or more any of CPUs.

In addition, programming interfaces to the data stored as part of the NFTPS processing (e.g., in the data repositories 1531-1533) can be available by standard means such as through C, C++, C#, and Java APIs; libraries for accessing files, databases, or other data repositories; through scripting languages such as XML; or through Web servers, FTP servers, or other types of servers providing access to stored data. The data repositories 1531-1533 may be implemented as one or more database systems, file systems, or any other method known in the art for storing such information, or any combination of the above, including implementations using distributed computing techniques. In addition, the business rules that guide the non-financial transactions may be implemented as stored procedures, methods attached to product “objects,” although other techniques are equally effective.

Also, the NFTPS 1525 may be implemented in a distributed environment that is comprised of multiple, even heterogeneous, computer systems and networks. In addition, different configurations and locations of code and data are contemplated for use. For example, in one embodiment, the NFTPS components (not shown) and data repositories 1531-1533 (e.g., corresponding to an orders data repository, a cards data repository, and a users data repository, respectively) are all located in physically different computer systems. In another embodiment, various NFTPS components (not shown) are hosted together on one server machine, while the data repositories 1531-1533 are all hosted on a separate server machine. A variety of distributed computing techniques are appropriate for implementing the components of a NFTPS in a distributed manner including, but not limited to, TCP/IP sockets, RPC, RMI, HTTP, and Web Services (XML-RPC, JAX-RPC, SOAP, etc.). In some embodiments, one or more of the data repositories 1531-1533 may be implemented in the context of, or provided by, known or proprietary database systems (e.g., MySQL®, PostgreSQL, Microsoft SQL Server™, Oracle®, etc.).

Furthermore, in some embodiments, some or all of the components of the NFTPS may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

In addition, the one or more point-of-sale computing systems 1550, one or more financial transaction processors 1560, and one or more fulfillment center computing systems 1570 may be implemented using known computer system hardware, software, and/or firmware techniques.

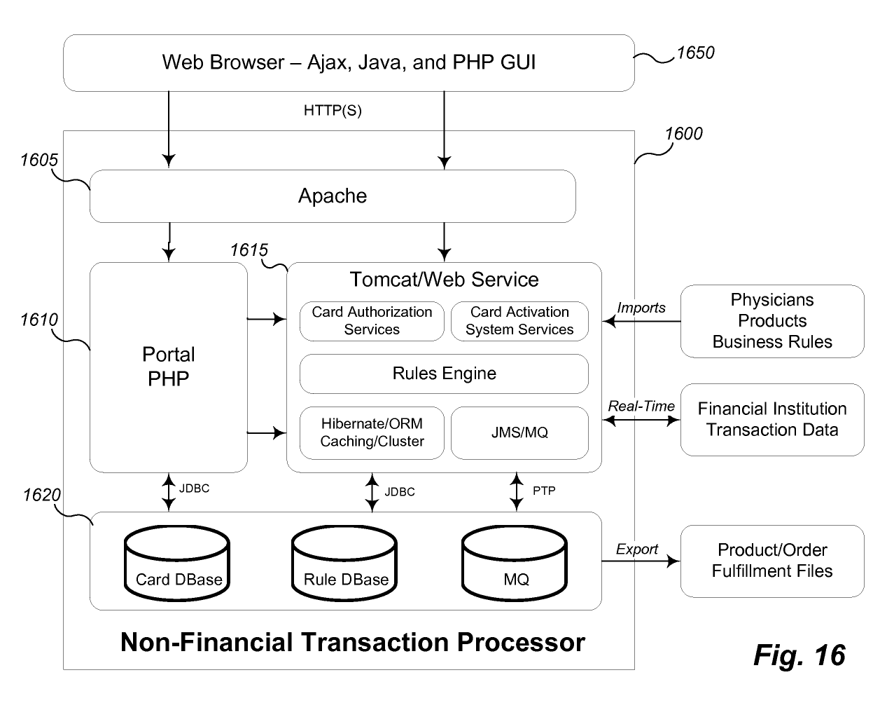

FIG. 16 illustrates one example embodiment of the components of an example NFTPS. The illustrated software system comprises support for card authorization and card activation, swipe processing, business rules processing, Web portal (user interface) support, and interfaces to the financial transaction processors and order fulfillment systems. Other capabilities may be similarly integrated.

In particular, FIG. 16 illustrates various implementation technologies that may be employed to implement an example embodiment of an NFTPS. In the illustrated embodiment, the NFTPS 1600 includes a Web server 1605, such as the Apache Web server, that provides network-based access to a portal 1610 implemented in the PHP programming language and to a Web service 1615. The portal 1610 and the Web service 1615 provide access to various functions of the NFTPS to either users or other software systems. For example, the portal 1610 may be accessed by a Web browser 1650 that executes a client-side user interface based on Ajax, Java, and/or PHP. In addition, the Web service 1615 may be accessed by external software systems, such as order fulfillment computing systems, financial transaction processors, etc. The Web service 1615 wraps various functions of the NFTPS, including card authorization services, card activation services, business rules processing, etc. The portal 1610 and Web service 1615 utilize a data access facility 1620 that includes one or more data repositories, such as a card database, a business rule database, and/or a messaging database.

Various security measures well known in the art may be implemented as part an SSOS. For example, in order to prevent access to or alteration of data in the various data repositories, the information may be stored in an encrypted format. A small number of transactions may be randomly selected and manually audited (e.g., by calling the healthcare professional to confirm the request). In addition, after a predetermined number of failed attempts (e.g., by supplying an incorrect security code, swiping the card in an unauthorized terminal, etc.), the card may be deactivated such that the card cannot be used to obtain future products or services.

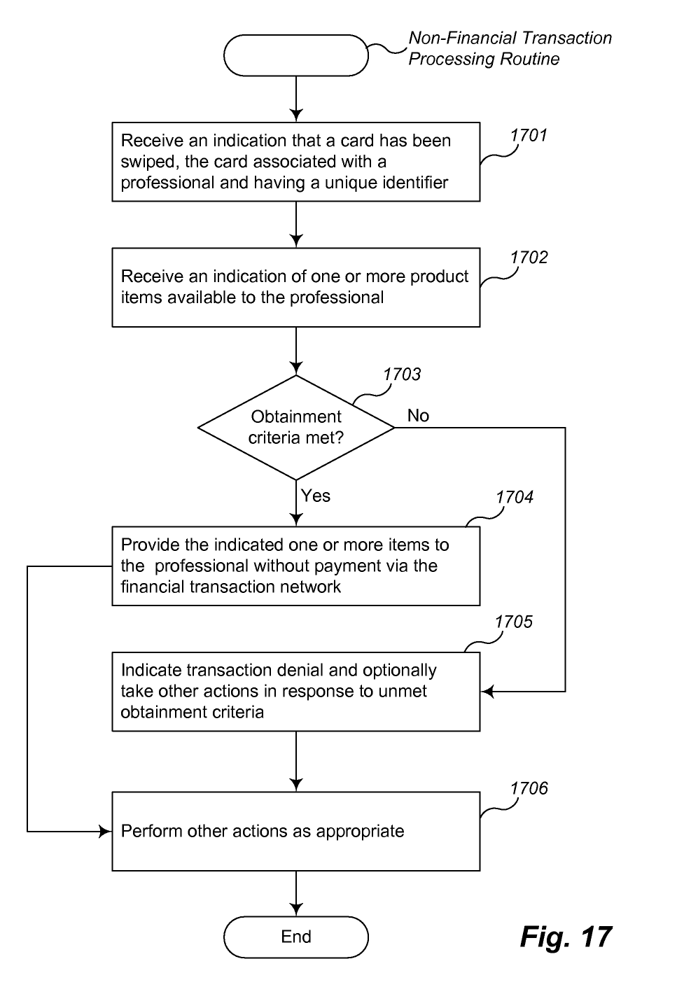

FIG. 17 is an example flow diagram of an example non-financial transaction processing routine provided by an example embodiment. The illustrated routine may be provided by, for example, execution of the non-financial transaction processor 1535 described with reference to FIG. 15. The illustrated routine processes non-financial transactions in response to a received indication of a card swipe.

More specifically, the routine begins at step 1701, where it receives an indication that a card has been swiped, the card associated with a professional and having a unique identifier. In a typical embodiment, the card is swiped in a receiving device, such as a point-of-sale terminal, that is communicatively coupled with the routine, such as via a communications network. The card is associated with a professional, such as a physician who participates in a product sampling program configured to gratuitously distribute product samples participating professionals, as described above.

In step 1702, the routine receives an indication of one or more product items available to the professional. The indication of the product items may be, for example, an item code such as one or more digits entered by the physician at the receiving device, the one or more digits may identify a particular product or service and may also include a security code. The indication of the product items may be received via a financial transaction network that is communicatively coupled to the receiving device, and ordinarily processes financial transactions performed via the receiving device (e.g., credit/debit card transactions). In some embodiments, services (as opposed to products) may be offered through a sampling program, and handled in a similar manner by this or a similar routine.

In step 1703, the routine determines whether criteria for obtaining the indicated one or more items have been met, and if so, proceeds to step 1704, else to step 1705. Determining whether such obtainment criteria have been met may be based on various factors, such as whether the professional is entitled to obtain the indicated items (e.g., whether the item code entered at the receiving device is associated with the card), whether the professional has exceeded a maximum number of items that may be ordered by the professional, whether the professional has exceeded a maximum frequency of item ordering, whether a provided security code is correct (e.g., matches a security code recorded in a data repository accessible to the routine), whether the card was swiped on an authorized receiving device (e.g., an identifier of the receiving device matches a receiving device associated with the professional), etc.

In step 1704, the routine initiates the provision of the indicated one or more items. Initiating the provision of the indicated items may include transmitting an order to a fulfillment computing system configured to initiate the packaging and/or shipping of the indicated items to an address associated with the professional (e.g., a business office). Initiating the provision of the indicated items may also include notifying the professional that the indicated items will be provided, such as by transmitting an approval code to the receiving device, sending an email to the professional, and/or dispatching a postal mail message to the professional. After step 1704, the routine proceeds to step 1706.

In step 1705, the routine indicates transaction denial and optionally takes other actions in response to the unmet obtainment criteria. Indicating a transaction denial may include determining and transmitting a denial code to the receiving device. In addition, the routine may optionally take other actions, such as notifying a customer service center (e.g., to provide notification of potentially unauthorized card use), deactivating the card, etc.

In step 1706, the routine performs other actions as appropriate. Such actions may include logging or otherwise recording information about the transaction, such as recording the time and date, recording whether the transaction succeeded, recording the number of items ordered, updating card state, etc. In addition, such actions may include generating a transaction report of approved and/or denied transactions.

After step 1706, the routine ends. In other embodiments, the routine may instead return to step 1701 to await receipt of further card swipe indications.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/980,396, entitled “OBTAINMENT OF PRODUCTS AND SERVICES USING NON-FINANCIAL TRANSACTIONS CONDUCTED OVER A FINANCIAL NETWORK,” filed Oct. 16, 2007, are incorporated herein by reference, in their entireties.

From the foregoing it will be appreciated that, although specific embodiments have been described herein for purposes of illustration, various modifications may be made without deviating from the spirit and scope of the disclosure. For example, other payment mediums (e.g., RFID tags, a smartcard) containing a unique identifier may be used instead of a magnetic card. Also, the methods, systems, and techniques discussed herein are applicable to different types of financial transaction networks, communication media (optical, wireless, cable, etc.) and devices (such as wireless handsets, electronic organizers, personal digital assistants, portable email machines, game machines, pagers, navigation devices such as GPS receivers, etc.).

1. A computer-implemented method for providing one or more items via a non-financial transaction over a financial transaction network, the method comprising:
receiving an indication that a card has been swiped in a receiving device, the card associated with a professional and having a unique identifier;
receiving through a financial transaction network an indication of one or more item codes associated with one or more products and/or services available to the professional; and
under the control of an entity that is not part of the financial transaction network,
automatically determining one or more items associated with the one or more indicated item codes;
determining whether criteria for obtaining the one or more determined items have been met; and
when it is determined that the criteria is met, initiating providing of the determined one or more items to the professional, the determined one or more items are provided to the professional without payment via the financial transaction network.

2. The method of claim 1 wherein the determined one or more items are provided to the user gratuitously.

3. The method of claim 1 wherein the determined one or more items are charged to an entity that markets one or more products to one or more clients of the professional.

4. The method of claim 1 wherein at least one of the one or more codes is associated with a pharmaceutical sample.

5. The method of claim 1 wherein the providing causes a pharmaceutical sample to be sent to the professional associated with the card.

6. The method of claim 1 wherein the determined one or more items are charged to an entity that employs the professional.

7. The method of claim 1, further comprising receiving through a financial transaction network an indication of a security code, and wherein the determining of whether the criteria has been met includes determining if the indicated security code matches a security code associated with the swiped card.

8. The method of claim 1 wherein the determining of whether the criteria has been met includes determining whether payment for the determined one or more items is available from a third-party entity.

9. The method of claim 8 wherein the card is associated with one or more item codes and the determining of whether the criteria has been met includes determining whether the one or more indicated item codes are associated with the card.

10. The method of claim 1, further comprising receiving through a financial transaction network an indication of an identifier of a point-of-sale terminal that is associated with the receiving device, and wherein the determining of whether the criteria have been met includes determining if the identifier of the point-of-sale terminal matches one or more point-of-sale terminals associated with the professional.

11. The method of claim 1 wherein at least one of the one or more item codes is associated with a service.

12. The method of claim 1, further comprising when it is determined that the criteria are met, sending an indication to the professional that the determined one or more items will be provided to the professional.

13. The method of claim 12 wherein the indication to the professional that the determined one or more items will be provided to the professional is at least one of an email or an indication on a point-of-sale device associated with the receiving device.

14. The method of claim 1, further comprising automatically determining a shipping address for the professional based at least in part on the unique identifier of the swiped card, and wherein the providing of the determined one or more items is performed by shipping the determined one or more items to the determined shipping address.

15. The method of claim 1 wherein the professional is at least one of a healthcare professional, a teacher, a police officer, a financial advisor, or a tradesman.

16. The method of claim 1 wherein the financial transaction network is at least one of a debit card processing network, an ATM card processing network, or a credit card processing network.

17. The method of claim 1 wherein the method is performed for multiple professionals.

18. The method of claim 1, further comprising logging the received indications and the time of the receiving of the indications.

19. The method of claim 18, further comprising generating a report based on the logged indications.

20. The method of claim 1, further comprising when it is determined that the criteria are not met, indicating that the criteria are not met.

21. The method of claim 20 wherein the indication that the criteria is not met includes deactivating the card such that no items may be subsequently obtained using the swiped card.

22. A computer-readable medium containing contents that, when executed, control a computer processor by performing a method comprising:
receiving an indication that a card has been swiped in a receiving device, the card associated with a professional and having a unique identifier;
receiving through a financial transaction network an indication of one or more item codes associated with one or more products and/or services available to the professional; and
under the control of an entity that is not part of the financial transaction network,
automatically determining one or more items associated with the one or more indicated item codes;
determining whether criteria for obtaining the one or more determined items have been met; and
when it is determined that the criteria is met, initiating providing of the determined one or more items to the professional, the determined one or more items are provided to the professional without payment via the financial transaction network.

23. The computer-readable medium of claim 22 wherein the computer-readable medium is a memory of a computing device.

24. The computer-readable medium of claim 22 wherein the contents are instructions that, when executed, cause the computing device to perform the method.

25. A computer system for providing one or more items via a non-financial transaction over a financial transaction network, the computer system comprising:
a memory; and
a module that is stored on the memory and that is configured, when executed, to:
receive an indication that a card has been swiped in a receiving device, the card associated with a professional and having a unique identifier;
receive through a financial transaction network an indication of one or more item codes associated with one or more products and/or services available to the professional;
automatically determine one or more items associated with the one or more indicated item codes;
determine whether criteria for obtaining the one or more determined items have been met; and
when it is determined that the criteria is met, initiate providing of the determined one or more items to the professional, the determined one or more items are provided to the professional without payment via the financial transaction network.

26. A method for distributing samples to professionals, the method comprising:
distributing a debit or credit card to a professional;
maintaining a computer system configured to:
receive an indication that a card has been swiped in a receiving device, the card associated with the professional and having a unique identifier;
receive through a financial transaction network an indication of one or more item codes associated with one or more products and/or services available to the professional;
automatically determine one or more items associated with the one or more indicated item codes;
determine whether criteria for obtaining the one or more determined items have been met; and
when it is determined that the criteria is met, initiate providing of the determined one or more items to the professional, the determined one or more items are provided to the professional without payment via the financial transaction network; and
receiving via the computer system an order for one or more samples from the professional using the distributed card; and
causing the ordered one or more samples to be provided to the professional.

27. A method for receiving one or more items, the method comprising:
swiping a credit or debit card in a receiving device;
indicating one or more item codes for a non-financial transaction over a financial transaction network; and
in response to the non-financial transaction over the financial transaction network, receiving one or more items associated with the one or more item codes.

28. A computer-implemented method for facilitating arranging a representative not affiliated with a financial entity to contact a decision maker, the method comprising:
receiving an indication that a card has been swiped in a receiving device, the card associated with a decision maker and having a unique identifier;
receiving through a financial transaction network an indication of one or more codes associated with the swiped card; and
under the control of an entity that is not part of the financial transaction network,
automatically determining a manner for contacting the decision maker based at least in part on the one or more indicated codes;
determining contact information for the decision maker based at least in part on the unique identifier; and
facilitating the decision maker being contacted by a representative in the determined manner using the determined contact information.

29. The method of claim 28 wherein the representative is associated with the entity.

30. The method of claim 28 wherein the representative is associated with a pharmaceutical entity.

31. The method of claim 28 wherein the manners of contacting the decision maker include telephone, email, instant messaging, or video conferencing.

32. The method of claim 28 wherein the decision maker is a customer of the entity.

33. The method of claim 28 wherein the decision maker is a professional that recommends a product and/or service to clients of the professional.
